(19) United States
(12) Patent Application Publication
(10) Pub. No.: US 2026/0205673 A1
(43) Pub. Date: Jul. 16, 2026

(54) Electronic Devices and Corresponding Systems and Methods for Causing Presentation of Summaries of Content Portions in Group Viewing Sessions

(71) Applicant: Motorola Mobility LLC, Chicago, IL (US)

(72) Inventors: Amit Kumar Agrawal, Bangalore (IN); Krishnan Raghavan, Bangalore (IN)

(21) Appl. No.: 19/025,595

(22) Filed: Jan. 16, 2025

(51) Int. Cl. H04N 21/8549; G06V 40/18; G10L 25/78

(52) U.S. Cl. CPC H04N 21/8549; G06V 40/18; G10L 25/78

(57) ABSTRACT

A method in an electronic device includes detecting, with one or more sensors, one or more persons within a media consumption environment while a companion electronic device delivers content. The method includes determining, by one or more processors, an interruption of content consumption by at least one person, gathering information related to content portions presented during the interruption, and causing the presentation of a summary of the information upon detecting a cessation of the interruption. The summary may include closed captioned text, audio-to-text conversion, and spoiler alerts. The method can also involve detecting interruptions through gaze direction, sound detection, and movement of companion devices.

### BACKGROUND

### Technical Field

This disclosure relates generally to electronic devices, and more particularly to electronic devices having user interfaces.

### Background Art

In recent years, communal viewing experiences have surged, largely driven by the rise of Over-The-Top (OTT) platforms. Streaming services have experienced exponential growth, particularly following the COVID-19 pandemic, as lockdowns and social distancing measures prompted individuals to seek entertainment and connection within their households. Consequently, families turned to OTT platforms as a convenient and versatile source of shared content, fostering bonding and enjoyment.

Despite the convenience and accessibility of OTT platforms, the family viewing experience often encounters significant challenges when one member is unable to watch for a few minutes due to various reasons such as attending a phone call, tending to household chores, or dealing with interruptions. These interruptions disrupt the continuity of the viewing experience, leaving the individual out of sync with the plot or missing developments in the story. This creates a dilemma where the individual either resumes watching without understanding what happened or disrupts others by asking for a recap or rewinding the content, which can be irritating and disruptive. This friction point potentially diminishes the enjoyment and cohesion of shared entertainment moments. It would be advantageous to have improved electronic devices, systems, and methods to address these issues.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory system in accordance with one or more embodiments of the disclosure.

FIG. 2 illustrates one explanatory electronic device in accordance with one or more embodiments of the disclosure.

FIG. 3 illustrates one or more method steps in accordance with one or more embodiments of the disclosure.

FIG. 4 illustrates another explanatory system in accordance with one or more embodiments of the disclosure.

FIG. 5 illustrates one or more method steps in accordance with one or more embodiments of the disclosure.

FIG. 6 illustrates one or more other method steps in accordance with one or more embodiments of the disclosure.

FIG. 7 illustrates an explanatory method in accordance with one or more embodiments of the disclosure.

FIG. 8 illustrates another explanatory method in accordance with one or more embodiments of the disclosure.

FIG. 9 illustrates a system in accordance with one or more embodiments of the disclosure.

FIG. 10 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to detecting, with one or more sensors of the electronic device, one or more persons within a media consumption environment of the electronic device while a companion electronic device in communication with the electronic device is delivering content to the media consumption environment, determining, by one or more processors operable with the one or more sensors, an interruption of consumption of the content by at least one person of the one or more persons, gathering, by the one or more processors, information related to content portions being presented during the interruption of the consumption of the content by the at least one person, and in response to the one or more sensors detecting a cessation of the interruption of the consumption of the content by the at least one person, causing, by the one or more processors, presentation of a summary of the information related to the content portions being presented during the interruption of the consumption of the content to the media consumption environment. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of using one or more processors to, in response to one or more sensors detecting an interruption of consumption of content being presented by a user interface of a companion electronic device to a media consumption environment by at least one person, generate a summary of content portions being presented during the interruption of the consumption of the content by the at least one person and cause a presentation of the summary in response to the one or more sensors detecting a cessation of the interruption of the consumption of the content by the at least one person as described herein. The non-processor circuits may include, but are not limited to, a radio receiver, a radio transmitter, signal drivers, clock circuits, power source circuits, and user input devices.

As such, these functions may be interpreted as steps of a method to perform detecting, with one or more sensors of the electronic device, an interruption of consumption of media content by at least one user within a media consumption environment and gathering, by one or more processors operable with the one or more sensors, information related to content portions being presented during the interruption of the consumption of the media content by the at least one user. The steps of the method can further include creating, by the one or more processors, a summary of the information related to the content portions being presented during the interruption of the consumption of the media content, detecting, with the one or more sensors, a cessation of the interruption of the consumption of the media content by the at least one user, and causing a presentation, by the one or more processors, of the summary of the information related to the content portions being presented during the interruption of the consumption of the media content on a user interface of another electronic device situated within the media consumption environment in response to detecting the cessation of the interruption.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

As noted above, OTT platforms have caused communal viewing experiences to surge in recent years. Families turn to OTT platforms as a convenient and versatile source of shared content, fostering bonding and enjoyment.

Despite the convenience and accessibility of OTT platforms, the family viewing experience often encounters significant challenges when one member is unable to watch for a few minutes due to various reasons such as attending a phone call, tending to household chores, or dealing with interruptions. These interruptions disrupt the continuity of the viewing experience, leaving the individual out of sync with the plot or missing developments in the story.

This creates a dilemma where the individual either resumes watching without understanding what happened or disrupts others by asking for a recap or rewinding the content, which can be irritating and disruptive. This friction point potentially diminishes the enjoyment and cohesion of shared entertainment moments.

To see how these problems can manifest, consider the following example: On a typical Friday night, Mike and his family gather for their weekly movie session. The plan to watch the movie “El Dorado,” which stands as a classic in the Western genre and was directed by the legendary Howard Hawks. El Dorado features iconic performances by John Wayne and Robert Mitchum.

The film's narrative revolves around a gunfighter and a sheriff who join forces to help a rancher and his family fight off a rival rancher trying to steal their water rights. The movie is renowned for the storyline, memorable characters, and the chemistry between the lead actors. The cinematography captures the rugged beauty of the Western landscape, while the script, filled with sharp dialogue and moments of humor, keeps the audience engaged throughout.

Mike and his family are particularly excited about watching “El Dorado” together. They have planned their weekly movie session around this classic, anticipating an evening filled with action, drama, and the timeless appeal of a well-crafted Western. The family's enthusiasm for the film highlights their appreciation for quality storytelling and the shared experience of enjoying a beloved movie together. The anticipation of watching “El Dorado” serves as a bonding moment for Mike and his family, reinforcing the importance of communal viewing experiences in their household

Unfortunately, Mitchum's character has his hat and badge stolen, a call summons Mike away for ten minutes, leaving him disoriented upon his return. Seeking clarification from his wife, he encounters her irritation as she pauses to explain plot points.

This scenario is not uncommon to Mike's family. In households worldwide, interruptions during communal viewing sessions are common. These interruptions can range from attending to phone calls, household chores, or other responsibilities, causing the interrupted individual to miss significant portions of the content.

Current solutions to address interruptions during media consumption often involve manual actions such as pausing the content or rewinding to catch up on missed portions. These methods can be cumbersome and disruptive to other viewers, leading to frustration and a less enjoyable viewing experience. Additionally, some systems may attempt to detect interruptions and pause the content automatically, but these solutions do not provide a summary of the missed content, leaving the interrupted viewer still needing to catch up manually.

Advantageously, embodiments of the disclosure address this issue by detecting when a viewer leaves the monitored area during media consumption. In one or more embodiments, the system then starts gathering a summary of the missed content using various techniques, such as interfacing with the media output device to fetch closed caption tracks or capturing audio and converting speech to text.

In one or more embodiments, upon the viewer's return, the system presents the summary on their personal device, ensuring they can seamlessly rejoin the viewing experience without disrupting others. This approach enhances the overall enjoyment and cohesion of shared entertainment moments, providing a practical solution to a common problem faced by families during group media consumption.

Embodiments of the disclosure address the issues associated with trying to “catch someone up” after a content presentation interruption by providing a comprehensive solution for summarizing missed content during group media consumption. In one or more embodiments, the system comprises an electronic device that detects when a consumer is in the monitored area during the presentation of media content by a media output device. In one or more embodiments, the system determines if the consumer has been interrupted and starts gathering a summary of the missed content. Upon the consumer's return, in one or more embodiments the system presents the summary on the device display, ensuring the viewer can seamlessly rejoin the viewing experience without disrupting others. This approach enhances the overall enjoyment and cohesion of shared entertainment moments.

In one or more embodiments, a method in an electronic device comprises detecting, with one or more sensors of the electronic device, one or more persons within a media consumption environment of the electronic device while a companion electronic device in communication with the electronic device is delivering content to the media consumption environment. In one or more embodiments, the method further includes determining, by one or more processors operable with the one or more sensors, an interruption of consumption of the content by at least one person of the one or more persons.

In one or more embodiments, the method involves gathering, by the one or more processors, information related to content portions being presented during the interruption of the consumption of the content by the at least one person. In one or more embodiments, in response to the one or more sensors detecting a cessation of the interruption of the consumption of the content by the at least one person, the method includes causing, by the one or more processors, presentation of a summary of the information related to the content portions being presented during the interruption of the consumption of the content to the media consumption environment. The summary may be presented on a user interface of another electronic device situated within the media consumption environment. Advantageously, the method ensures that the viewer can seamlessly rejoin the viewing experience without disrupting others, thereby enhancing the overall enjoyment and cohesion of shared entertainment moments.

Advantageously, this method enhances the user experience by ensuring that individuals who experience interruptions can quickly catch up on missed content without disrupting the viewing experience for others. By using sensors to detect interruptions and gather content information, the system provides a seamless way for users to stay in sync with the media being consumed. This approach reduces the need for manual interventions such as pausing or rewinding the content, which can be cumbersome and disruptive.

Additionally, the method supports the creation of personalized summaries for each user, accommodating multiple interruptions and ensuring that each user receives relevant information tailored to their specific interruption period. This improves the overall cohesion and enjoyment of group viewing sessions, making it easier for families and groups to share entertainment experiences without frustration.

In one or more embodiments, an electronic device comprises one or more sensors and one or more processors operable with the one or more sensors. In one or more embodiments, the one or more processors, in response to the one or more sensors detecting an interruption of consumption of content being presented by a user interface of a companion electronic device to a media consumption environment by at least one person, generate a summary of content portions being presented during the interruption of the consumption of the content by the at least one person. In one or more embodiments, the one or more processors cause a presentation of the summary in response to the one or more sensors detecting a cessation of the interruption of the consumption of the content by the at least one person.

The sensors may include image capture devices, microphones, or communication devices that detect movement or sound within the media consumption environment. In one or more embodiments, the processors utilize the gathered data to create a coherent summary of the missed content, ensuring that the user can seamlessly rejoin the viewing experience without disrupting others. The summary may be presented on the user interface of another electronic device situated within the media consumption environment.

Advantageously, this arrangement allows the electronic device to monitor the media consumption environment and detect when a user is interrupted. By utilizing sensors such as image capture devices, microphones, or communication devices, the system can accurately determine when a user stops consuming content. The processors then gather information about the content presented during the interruption, ensuring that the user does not miss any important developments.

Upon detecting that the user has returned, the processors can generate a summary of the missed content and present it to the user. This ensures that the user can quickly catch up on what was missed without disrupting the viewing experience for others. The summary can be presented in various formats, such as text, audio, or video, providing flexibility in how the information is delivered.

Advantageously, this method enhances the user experience by reducing the need for manual interventions like pausing or rewinding the content, which can be disruptive to other viewers. It also supports personalized summaries for multiple users, accommodating different interruption periods and ensuring that each user receives relevant information tailored to their specific needs. This improves the overall cohesion and enjoyment of group viewing sessions, making it easier for families and groups to share entertainment experiences without frustration.

In one or more embodiments, a method in an electronic device comprises detecting, with one or more sensors of the electronic device, an interruption of consumption of media content by at least one user within a media consumption environment. In one or more embodiments, the method involves gathering, by one or more processors operable with the one or more sensors, information related to content portions being presented during the interruption of the consumption of the media content by the at least one user.

In one or more embodiments, the method further includes creating, by the one or more processors, a summary of the information related to the content portions being presented during the interruption of the consumption of the media content. In one or more embodiments, the method also comprises detecting, with the one or more sensors, a cessation of the interruption of the consumption of the media content by the at least one user.

In one or more embodiments, upon detecting the cessation of the interruption, the method includes causing a presentation, by the one or more processors of the summary of the information related to the content portions being presented during the interruption of the consumption of the media content on a user interface of another electronic device situated within the media consumption environment. In one or more embodiments, the summary includes a spoiler alert notification.

The method ensures that the user can seamlessly rejoin the viewing experience without disrupting others, thereby enhancing the overall enjoyment and cohesion of shared entertainment moments. The summary may be presented in the voice of a participant depicted in the content, providing a personalized and engaging way for the user to catch up on missed portions of the media content.

Advantageously, the method enhances the user experience by ensuring that individuals who experience interruptions can quickly catch up on missed content without disrupting the viewing experience for others. By using sensors to detect interruptions and gather content information, the system provides a seamless way for users to stay in sync with the media being consumed. This approach reduces the need for manual interventions such as pausing or rewinding the content, which can be cumbersome and disruptive.

Additionally, the method supports the creation of personalized summaries for each user, accommodating multiple interruptions and ensuring that each user receives relevant information tailored to their specific interruption period. This improves the overall cohesion and enjoyment of group viewing sessions, making it easier for families and groups to share entertainment experiences without frustration.

The use of sensors to detect interruptions and gather content information ensures that the system can accurately determine when a user stops consuming content and when they return. This allows the system to create a coherent summary of the missed content, ensuring that the user does not miss any important developments. The summary can be presented in various formats, such as text, audio, or video, providing flexibility in how the information is delivered.

By presenting the summary on another electronic device situated within the media consumption environment, the method ensures that the user can quickly catch up on what was missed without disrupting the viewing experience for others. This enhances the overall enjoyment and cohesion of shared entertainment moments, providing a practical solution to a common problem faced by families during group media consumption. Other advantages will be described below. Still others will be obvious to those of ordinary skill in the art having the benefit of this disclosure.

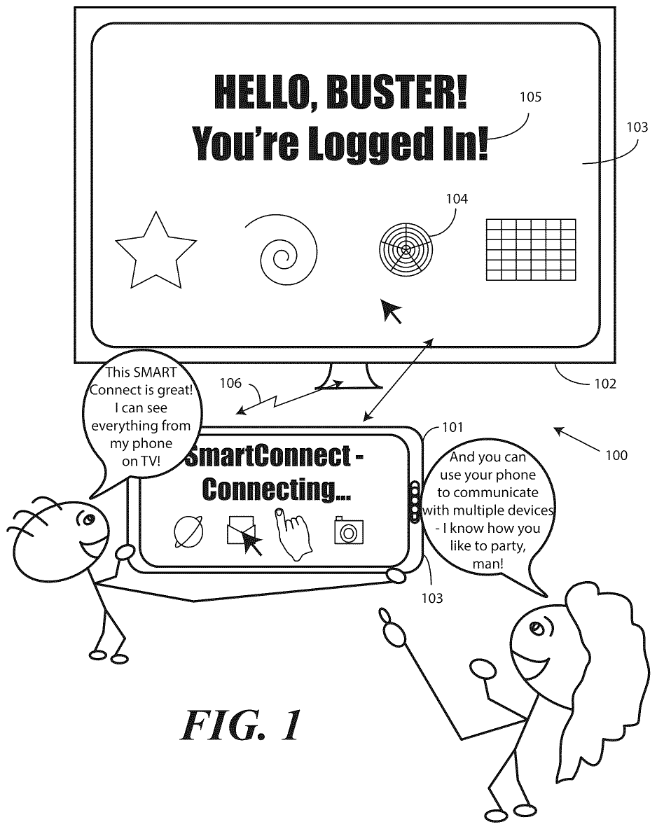

Turning now to FIG. 1, illustrated therein is one explanatory system 100 configured in accordance with one or more embodiments of the disclosure illustrating an electronic device 101 operating in conjunction with a content presentation companion device 102 in accordance with one or more embodiments of the disclosure. In FIG. 1, the electronic device 101 and the content presentation companion device 102 operate in tandem as a system, with the electronic device 101 providing the processing power to generate and/or receive content that could be presented on the display of the electronic device 101 and/or output from loudspeakers of the electronic device 101, but that is instead redirected for presentation using the content presentation companion device 102. This allows the content presentation companion device 102 to serve as the primary display device and/or the primary audio output for the electronic device 101.

As shown in FIG. 1, the electronic device 101 is electronically in communication with the content presentation companion device 102 using a wireless electrical communication channel 106. When the electronic device 101 is electronically in communication with the content presentation companion device 102, this allows the electronic device 101 to use the larger display 103 of the content presentation companion device 102 to present visible portions of media content and/or the more powerful speakers of the content presentation companion device 102 to present audible portions of the media content.

Illustrating by example, in one or more embodiments the electronic device 101 can operate in a “content redirection” mode by presenting content such as movies, videos, images, and even a traditional computer user interface, that are generated or received by the electronic device 101 and are redirected to the display 103 and/or loudspeakers of the content presentation companion device 102. When, for instance, when Mike and his family stream “El Dorado” using an OTT platform operating on one or more processors of the electronic device 101, the content redirection mode can allow the electronic device 101 to serve as a remote control device while characters, scenes, events, and other characteristics of the movie are presented on the display 103 of the content presentation companion device 102.

Embodiments of the disclosure contemplate that with the advanced computing power available in smartphones and other electronic devices, users often play games and consume music, movies, videos, television shows, and other content using these devices. Additionally, they can perform work operations such as sending email, managing files, working on documents and spreadsheets, and so forth.

By establishing a wireless electrical communication channel 106 between the electronic device 101 and the content presentation companion device 102, the processing power of the electronic device 101 can be leveraged to deliver this content to the content presentation companion device 102 for presentation of that content on the display 103 of the content presentation companion device 102. This allows a user to watch television, listen to music, play video games, work on homework or office work, video call friends and family, or perform other tasks using the one or more processors of the electronic device 101 combined with the large display 103 and/or loudspeakers of the content presentation companion device 102.

Using a content redirection feature, a small electronic device 101 such as the smartphone shown in FIG. 1 can connect to connect to a content presentation companion device 102 such as a larger monitor, television, loudspeakers, or other device having a larger screen or more powerful audio output capabilities. Using the content redirection feature, users can wirelessly stream video, music, gaming application output, or other content from the electronic device 101 to the larger display 103 and/or more powerful loudspeakers of the content presentation companion device 102 with no loss in performance. Resolution of the images 104 on the content presentation companion device 102 can be as high as 4K with frame rates that present the content 105 without flicker or distortion. In the illustrative embodiment of FIG. 1, neither a cable nor a docking station is required to use the content redirection feature since communication occurs across a wireless electrical communication channel 106.

When using the content redirection feature, the electronic device 101 can function as a mouse, trackpad, gaming controller, or other control device while the content 105 is being presented on the content presentation companion device 102. The content redirection feature can be used for presenting games, movies, pictures, videos, television shows, computer desktops, or movies on the larger display 103 and/or loudspeakers of a content presentation companion device 102 while a controller user interface used to control the content is presented locally on the display of the electronic device 101. Additionally, the controller user interface presented on the electronic device 101 can be used to control gaming applications, video conferences, and other content presentation tasks.

Embodiments of the disclosure advantageously provide a more intelligent system that dynamically enhances the feature set offered by the electronic device 101 by causing the electronic device 101 to deliver content to the content presentation companion device 102 while at the same time serving as a controller for the content presentation companion device 102. When a controller user interface is presented on the display of the electronic device 101, a user can deliver user input to the controller user interface to control the content being presented on the content presentation companion device 102. For instance, in one or more embodiments a user interface feature being presented on the content presentation companion device 102 can be adjusted using a controller user interface that is presented on a display of the electronic device 101.

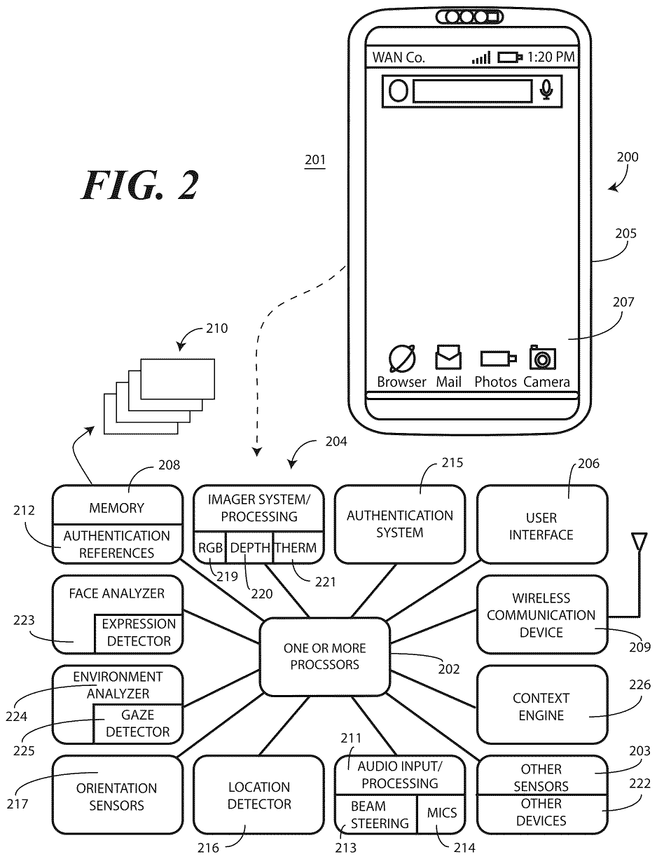

Before turning to the user interface enhancements and how they operate, a deeper look into the hardware of the electronic device 101 will be provided. Turning now to FIG. 2, illustrated therein is one explanatory electronic device 200 configured in accordance with one or more embodiments of the disclosure.

Illustrated in FIG. 2 is one explanatory electronic device 200 in accordance with one or more embodiments of the disclosure. The electronic device 200 of FIG. 1 is a portable electronic device and is shown as a smartphone for illustrative purposes. However, it should be obvious to those of ordinary skill in the art having the benefit of this disclosure that other electronic devices may be substituted for the explanatory smart phone of FIG. 1. For example, the electronic device 200 could equally be a conventional desktop computer, palm-top computer, a tablet computer, a gaming device, a media player, or other device. The electronic device 200 is configured, in one or more embodiments, to identify one or more persons positioned within an environment 201 of the electronic device 200.

In one or more embodiments, the electronic device 200 includes various sensors 203. These sensors 203 can include an imager system, an audio sensor, proximity detectors, orientation sensors, a location detector, a context sensor, a radio frequency (RF) sensor, a presence sensor, a beacon, or other sensors.

The electronic device 200 also includes on or more processors 202 that are operable with the one or more sensors 203. In one or more embodiments, the one or more sensors 203 are operable to detect a plurality of persons within a predefined environment 201 about the electronic device 200. As will be described in more detail below, in one or more embodiments the one or more sensors 203, in conjunction with one or more processors 202, can also identify at least one person of the plurality of persons as an authorized user of the electronic device 200.

In one or more embodiments, the one or more sensors 203, in conjunction with the one or more processors 202, can also identify one or more of the plurality of persons as well. If, for example, a second person is a good friend of the authorized user and is frequently within the environment 201 of the electronic device 200, the one or more sensors 203 and/or one or more processors 202 may be able to identify that person as well. While the other person may not be identified as the authorized user of the electronic device 200, they may still be identified for other purposes, as will be explained in more detail below.

Also illustrated in FIG. 2 is one explanatory block diagram schematic 204 of the explanatory electronic device 200. In one or more embodiments, the block diagram schematic 204 is configured as a printed circuit board assembly disposed within a housing 205 of the electronic device 200. Various components can be electrically coupled together by conductors or a bus disposed along one or more printed circuit boards.

The illustrative block diagram schematic 204 of FIG. 1 includes many different components. Embodiments of the disclosure contemplate that the number and arrangement of such components can change depending on the particular application. Accordingly, electronic devices configured in accordance with embodiments of the disclosure can include some components that are not shown in FIG. 2, and other components that are shown may not be needed and can therefore be omitted.

The illustrative block diagram schematic 204 includes a user interface 206. In one or more embodiments, the user interface 206 includes a display 207, which may optionally be touch sensitive. In one embodiment, users can deliver user input to the display 207 of such an embodiment by delivering touch input from a finger, stylus, or other objects disposed proximately with the display 207. In one embodiment, the display 207 is configured as an active matrix organic light emitting diode (AMOLED) display. However, it should be noted that other types of displays, including liquid crystal displays, suitable for use with the user interface 206 would be obvious to those of ordinary skill in the art having the benefit of this disclosure.

In one embodiment, the electronic device includes one or more processors 202. In one embodiment, the one or more processors 202 can include an application processor and, optionally, one or more auxiliary processors. One or both of the application processor or the auxiliary processor(s) can include one or more processors.

One or both of the application processor or the auxiliary processor(s) can be a microprocessor, a group of processing components, one or more ASICs, programmable logic, or other type of processing device. The application processor and the auxiliary processor(s) can be operable with the various components of the block diagram schematic 204. Each of the application processor and the auxiliary processor(s) can be configured to process and execute executable software code to perform the various functions of the electronic device with which the block diagram schematic 204 operates. A storage device, such as memory 208, can optionally store the executable software code used by the one or more processors 202 during operation.

In this illustrative embodiment, the block diagram schematic 204 also includes a communication circuit 209 that can be configured for wired or wireless communication with one or more other devices or networks. The networks can include a wide area network, a local area network, and/or personal area network. The communication circuit 109 may also utilize wireless technology for communication, such as, but are not limited to, peer-to-peer or ad hoc communications such as HomeRF, Bluetooth and IEEE 802.11, and other forms of wireless communication such as infrared technology. The communication circuit 109 can include wireless communication circuitry, one of a receiver, a transmitter, or transceiver, and one or more antennas.

In one embodiment, the one or more processors 202 can be responsible for performing the primary functions of the electronic device with which the block diagram schematic 204 is operational. For example, in one embodiment the one or more processors 202 comprise one or more circuits operable with the user interface 206 to present presentation information to a user. The executable software code used by the one or more processors 202 can be configured as one or more modules 210 that are operable with the one or more processors 202. Such modules 210 can store instructions, control algorithms, and so forth.

In one or more embodiments, the block diagram schematic 204 includes an audio input/processor 211. The audio input/processor 211 is operable to receive audio input from an environment (201) about the electronic device 200. The audio input/processor 211 can include hardware, executable code, and speech monitor executable code in one embodiment. The audio input/processor 211 can be operable with one or more predefined authentication references 212 stored in memory 208.

With reference to audio input, the predefined authentication references 212 can comprise representations of basic speech models, representations of trained speech models, or other representations of predefined audio sequences that are used by the audio input/processor 211 to receive and identify voice commands that are received with audio input captured by an audio capture device. In one embodiment, the audio input/processor 211 can include a voice recognition engine. Regardless of the specific implementation utilized in the various embodiments, the audio input/processor 211 can access various speech models stored with the predefined authentication references 212 to identify speech commands.

The audio input/processor 211 can include a beam steering engine 213 comprising one or more microphones 214. Input from the one or more microphones 214 can be processed in the beam steering engine 213 such that the one or more microphones define a virtual microphone. This virtual microphone can define an acoustic reception cone that can be virtually “steered” around the electronic device 200. Alternatively, actual steering can occur as well, such as switching between a left and right microphone or a front and back microphone or switching various microphones ON and OFF individually. In one or more embodiments, two or more microphones 214 can be included for selective beam steering by the beam steering engine 213.

Illustrating by example, a first microphone can be located on a first side of the electronic device 200 for receiving audio input from a first direction, while a second microphone can be placed on a second side of the electronic device 200 for receiving audio input from a second direction. These microphones can be “steered” by selectively turning them ON and OFF.

The beam steering engine 213 can then select between the first microphone and the second microphone to beam steer audio reception toward an object, such as a user delivering audio input. This beam steering can be responsive to input from other sensors, such as imagers, facial depth scanners, thermal sensors, or other sensors. For example, an imager can estimate a location of a person's face and deliver signals to the beam steering engine 213 alerting it in which direction to focus the acoustic reception cone and/or steer the first microphone and the second microphone, thereby adding confirmation to audio steering and saving time. Where multiple people are around the electronic device 200, this steering advantageously directs a beam reception cone to the authorized user.

Alternatively, the beam steering engine 213 processes and combines the signals from two or more microphones to perform beam steering. The one or more microphones 214 can be used for voice commands. In response to control of the one or more microphones 214 by the beam steering engine 213, a user location direction can be determined. The beam steering engine 213 can then select between the first microphone and the second microphone to beam steer audio reception toward the user. Alternatively, the audio input/processor 211 can employ a weighted combination of the microphones to beam steer audio reception toward the user.

In one embodiment, the audio input/processor 211 is configured to implement a voice control feature that allows a user to speak a specific device command to cause the one or more processors 202 to execute a control operation. For example, the user may say, “Authenticate Me Now.” This statement comprises a device command requesting the one or more processors to cooperate with the authentication system 215 to authenticate a user. Consequently, this device command can cause the one or more processors 202 to access the authentication system 215 and begin the authentication process. In short, in one embodiment the audio input/processor 211 listens for voice commands, processes the commands and, in conjunction with the one or more processors 202, performs a touchless authentication procedure in response to voice input.

The one or more processors 202 can perform filtering operations on audio input received by the audio input/processor 211. For example, in one embodiment the one or more processors 202 can filter the audio input into authorized user generated audio input, i.e., first audio input, and other audio input, i.e., second audio input.

Various sensors 203 can be operable with the one or more processors 202. A first example of a sensor that can be included with the various sensors 203 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 202, to detect an object in close proximity with—or touching—the surface of the display 207 or the housing 205 of the electronic device 200 by establishing electric field lines between pairs of capacitive sensors and then detecting perturbations of those field lines.

The electric field lines can be established in accordance with a periodic waveform, such as a square wave, sine wave, triangle wave, or other periodic waveform that is emitted by one sensor and detected by another. The capacitive sensors can be formed, for example, by disposing indium tin oxide patterned as electrodes on the substrate. Indium tin oxide is useful for such systems because it is transparent and conductive. Further, it is capable of being deposited in thin layers by way of a printing process. The capacitive sensors may also be deposited on the substrate by electron beam evaporation, physical vapor deposition, or other various sputter deposition techniques.

Another example of a sensor 203 is a geo-locator that serves as a location detector 216. In one embodiment, the location detector 216 is able to determine location data when authenticating a user. Location can be determined by capturing the location data from a constellation of one or more earth orbiting satellites, or from a network of terrestrial base stations to determine an approximate location. The satellite positioning systems based location fixes of the location detector 216 autonomously or with assistance from terrestrial base stations, for example those associated with a cellular communication network or other ground based network, or as part of a Differential Global Positioning System (DGPS), as is well known by those having ordinary skill in the art. The location detector 216 may also be able to determine location by locating or triangulating terrestrial base stations of a traditional cellular network, such as a CDMA network or GSM network, or from other local area networks, such as Wi-Fi networks.

One or more motion detectors can be configured as an orientation detector 217 that determines an orientation and/or movement of the electronic device 200 in three-dimensional space. Illustrating by example, the orientation detector 217 can include an accelerometer, gyroscopes, or other device to detect device orientation and/or motion of the electronic device 200. Using an accelerometer as an example, an accelerometer can be included to detect motion of the electronic device. Additionally, the accelerometer can be used to sense some of the gestures of the user, such as one talking with their hands, running, or walking.

The orientation detector 217 can determine the spatial orientation of an electronic device 200 in three-dimensional space by, for example, detecting a gravitational direction. In addition to, or instead of, an accelerometer, an electronic compass can be included to detect the spatial orientation of the electronic device relative to the earth's magnetic field. Similarly, one or more gyroscopes can be included to detect rotational orientation of the electronic device 200.

An authentication system 215 is operable with the one or more processors 202. A first authenticator 218 of the authentication system 215 can include an imager 219, a depth imager 220, and a thermal sensor 221, or any of these in any combination. In one embodiment, the imager 219 comprises a two-dimensional imager configured to receive at least one image of a person within an environment of the electronic device 200. In one embodiment, the imager 219 comprises a two-dimensional Red-Green-Blue (RGB) or Near-Infrared (NIR) imager. In another embodiment, the imager 219 comprises an infrared imager. Other types of imagers suitable for use as the imager 219 of the authentication system will be obvious to those of ordinary skill in the art having the benefit of this disclosure. The authentication system 215 can optionally be configured as a touch system (Pincode, fingerprint sensor) or other touchless systems (voice authentication, iris detection/authentication).

The thermal sensor 121 can also take various forms. In one embodiment, the thermal sensor 121 is simply a proximity sensor component included with the other components 222. In another embodiment, the thermal sensor 121 comprises a simple thermopile. In another embodiment, the thermal sensor 121 comprises an infrared imager that captures the amount of thermal energy emitted by an object. Other types of thermal sensors 121 will be obvious to those of ordinary skill in the art having the benefit of this disclosure.

The depth imager 220 can take a variety of forms. In a first embodiment, the depth imager 220 comprises a pair of imagers separated by a predetermined distance, such as three to four images. This “stereo” imager works in the same way the human eyes do in that it captures images from two different angles and reconciles the two to determine distance.

In another embodiment, the depth imager 220 employs a structured light laser. The structured light laser projects tiny light patterns that expand with distance. These patterns land on a surface, such as a user's face, and are then captured by an imager. By determining the location and spacing between the elements of the pattern, three-dimensional mapping can be obtained.

In still another embodiment, the depth imager 220 comprises a time of flight device. Time of flight three-dimensional sensors emit laser or infrared pulses from a photodiode array. These pulses reflect back from a surface, such as the user's face. The time it takes for pulses to move from the photodiode array to the surface and back determines distance, from which a three-dimensional mapping of a surface can be obtained. Regardless of embodiment, the depth imager 220 adds a third “z-dimension” to the x-dimension and y-dimension defining the two-dimensional image captured by the imager 219, thereby enhancing the security of using a person's face as their password in the process of authentication by facial recognition.

In one or more embodiments, the authentication system 215 can be operable with a face analyzer 223 and an environmental analyzer 224. The face analyzer 223 and/or environmental analyzer 224 can be configured to process an image or depth scan of an object and determine whether the object matches predetermined criteria by comparing the image or depth scan to one or more predefined authentication references 212 stored in memory 208.

For example, the face analyzer 223 and/or environmental analyzer 224 can operate as an authentication module configured with optical and/or spatial recognition to identify objects using image recognition, character recognition, visual recognition, facial recognition, color recognition, shape recognition, and the like. Advantageously, the face analyzer 223 and/or environmental analyzer 224, operating in tandem with the authentication system 215, can be used as a facial recognition device to determine the identity of one or more persons detected about the electronic device 200.

These persons can be further identified as an identified, authorized user of the electronic device, or identified, non-authorized user of the electronic device 200. If, for example, the imager 219 has captured images and/or the depth imager 220 has captured depth scans of a friend of the authorized user, the authorized user can optionally deliver the user input to the user interface 206 to add identifying characteristics to this data, such as the person's name, relationship to the authorized user, and so forth. Accordingly, the face analyzer 223 and/or environmental analyzer 224 are capable of identifying a large number of persons where such identifying characteristics have been previously stored with the image or depth scan data, even though only one identifiable person may be authenticated as the authorized user of the electronic device 200.

In one embodiment when the authentication system 215 detects a person, one or both of the imager 219 and/or the depth imager 220 can capture a photograph and/or depth scan of that person. The authentication system 215 can then compare the image and/or depth scan to one or more predefined authentication references 212 stored in the memory 208. This comparison, in one or more embodiments, is used to confirm beyond a threshold authenticity probability that the person's face—both in the image and the depth scan-sufficiently matches one or more of the predefined authentication references 212 stored in the memory 208 to identify a person. Where the predefined authentication reference 212 indicates that the identified person is also the authorized user of the electronic device 200, the authentication system 215 can further authenticate that particular person as an authorized user of the electronic device 200.

Beneficially, this optical recognition performed by the authentication system 215 operating in conjunction with the face analyzer 223 and/or environmental analyzer 224 allows access to the electronic device 200 only when one of the persons detected about the electronic device 200 are sufficiently identified as an authorized user of the electronic device 200. However, at the same time, when the imager 219 captures an image of an environment 201 of the electronic device 200, and that environment 201 comprises one or more persons, the optical recognition performed by the authentication system 215 operating in conjunction with the face analyzer 223 and/or environmental analyzer 224 allows for the identification of any person who has corresponding identifying characteristics stored with the image or depth scan data in the memory 208. Thus, where four persons are within the environment 201 of the electronic device 200, the optical recognition performed by the authentication system 215 operating in conjunction with the face analyzer 223 and/or environmental analyzer 224 may identify one as an authorized user of the electronic device 200, one as a friend of the authorized user, one as a cousin of the authorized user, and so forth.

In one or more embodiments the one or more processors 202, working with the authentication system 215 and the face analyzer 223 and/or environmental analyzer 224 can determine whether at least one image captured by the imager 219 matches a first predefined criterion, whether at least one facial depth scan captured by the depth imager 220 matches a second predefined criterion, and whether the thermal energy identified by the thermal sensor 121 matches a third predefined criterion, with the first criterion, second criterion, and third criterion being defined by the reference files and predefined temperature range. The first criterion may be a skin color, eye color, and hair color, while the second criterion is a predefined facial shape, ear size, and nose size. The third criterion may be a temperature range of between 95 and 101 degrees Fahrenheit. In one or more embodiments, the one or more processors 202 use this information to identify a person when the at least one image matches the first predefined criterion, the at least one facial depth scan matches the second predefined criterion, and the thermal energy matches the third predefined criterion. Where different sensors are used, such as an audio sensor, these criteria may change. For example, the first predefined criterion may be whether a detected voice matches previous registered samples. Where the predefined authentication reference 112 indicates that the identified person is also the authorized user of the electronic device 200, the authentication system 215 can further authenticate that particular person as an authorized user of the electronic device 200.

In one or more embodiments, a user can “train” the electronic device 200 by storing predefined authentication references 212 in the memory 208 of the electronic device 200. Illustrating by example, a user may take a series of pictures. They can include identifiers of special features such as eye color, sink color, air color, weight, and height. They can include the user standing in front of a particular wall, which is identifiable by the environmental analyzer from images captured by the imager 219. They can include the user raising a hand, touching hair, or looking in one direction, such as in a profile view. These can then be stored as predefined authentication references 212 in the memory 208 of the electronic device 200. This can be done not only for an authorized user, but others as well as described above.

In other embodiments, the seamless authentication offered by the authentication system 215 can be substituted with a more traditional authentication system. Illustrating by example, rather than employing the authentication system 215 the electronic device 200 may authenticate an authorized user via entry of a pincode. In still another embodiment, the authentication system 215 the electronic device 200 may authenticate an authorized user via a fingerprint sensor. In still another embodiment, the authentication system 215 the electronic device 200 may authenticate an authorized user via detection of a companion device, such as a smartwatch, via a near field wireless communication connection such as Bluetooth.sup.TM or radio frequency received signal strength indication. Where this latter embodiment occurs, content from the two mobile devices in proximity can be merged onto the unlocked device, e.g., favorite apps, common history, matching preferences, etc.

A gaze detector 225 can be operable with the authentication system 215 operating in conjunction with the face analyzer 223. The gaze detector 225 can comprise sensors for detecting the user's gaze point. The gaze detector 225 can optionally include sensors for detecting the alignment of a user's head in three-dimensional space. Electronic signals can then be processed for computing the direction of user's gaze in three-dimensional space. The gaze detector 225 can further be configured to detect a gaze cone corresponding to the detected gaze direction, which is a field of view within which the user may easily see without diverting their eyes or head from the detected gaze direction. The gaze detector 225 can be configured to alternately estimate gaze direction by inputting images representing a photograph of a selected area near or around the eyes. It will be clear to those of ordinary skill in the art having the benefit of this disclosure that these techniques are explanatory only, as other modes of detecting gaze direction can be substituted in the gaze detector 225 of FIG. 2.

The face analyzer 223 can include its own image/gaze detection-processing engine as well. The image/gaze detection-processing engine can process information to detect a user's gaze point. The image/gaze detection-processing engine can optionally also work with the depth scans to detect an alignment of a user's head in three-dimensional space. Electronic signals can then be delivered from the imager 219 or the depth imager 220 for computing the direction of user's gaze in three-dimensional space. The image/gaze detection-processing engine can further be configured to detect a gaze cone corresponding to the detected gaze direction, which is a field of view within which the user may easily see without diverting their eyes or head from the detected gaze direction. The image/gaze detection-processing engine can be configured to alternately estimate gaze direction by inputting images representing a photograph of a selected area near or around the eyes. It can also be valuable to determine if the user wants to be authenticated by looking directly at device. The image/gaze detection-processing engine can determine not only a gazing cone but also if an eye is looking in a particular direction to confirm user intent to be authenticated.

Other components 222 operable with the one or more processors 202 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The other components 222 can also include proximity sensors. The proximity sensors fall into one of two camps: active proximity sensors and “passive” proximity sensors. Either the proximity detector components or the proximity sensor components can be generally used for gesture control and other user interface protocols, some examples of which will be described in more detail below.

As used herein, a “proximity sensor component” comprises a signal receiver only that does not include a corresponding transmitter to emit signals for reflection off an object to the signal receiver. A signal receiver only can be used due to the fact that a user's body or other heat generating object external to device, such as a wearable electronic device worn by user, serves as the transmitter. Illustrating by example, in one the proximity sensor components comprise a signal receiver to receive signals from objects external to the housing 205 of the electronic device 200. In one embodiment, the signal receiver is an infrared signal receiver to receive an infrared emission from an object such as a human being when the human is proximately located with the electronic device 200. In one or more embodiments, the proximity sensor component is configured to receive infrared wavelengths of about four to about ten micrometers. This wavelength range is advantageous in one or more embodiments in that it corresponds to the wavelength of heat emitted by the body of a human being.

Additionally, detection of wavelengths in this range is possible from farther distances than, for example, would be the detection of reflected signals from the transmitter of a proximity detector component. In one embodiment, the proximity sensor components have a relatively long detection range so as to detect heat emanating from a person's body when that person is within a predefined thermal reception radius. For example, the proximity sensor component may be able to detect a person's body heat from a distance of about fifteen feet in one or more embodiments. The ten-foot dimension can be extended as a function of designed optics, sensor active area, gain, lensing gain, and so forth.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level. Simulations show that a group of infrared signal receivers can operate with a total current drain of just a few microamps.

In one embodiment, the signal receiver of each proximity sensor component can operate at various sensitivity levels so as to cause the at least one proximity sensor component to be operable to receive the infrared emissions from different distances. For example, the one or more processors 202 can cause each proximity sensor component to operate at a first “effective” sensitivity so as to receive infrared emissions from a first distance. Similarly, the one or more processors 202 can cause each proximity sensor component to operate at a second sensitivity, which is less than the first sensitivity, so as to receive infrared emissions from a second distance, which is less than the first distance. The sensitivity change can be effected by causing the one or more processors 202 to interpret readings from the proximity sensor component differently.

By contrast, proximity detector components include a signal emitter and a corresponding signal receiver, which constitute an “active IR” pair. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers. The infrared transmitters are configured, in one embodiment, to transmit infrared signals having wavelengths of about 860 nanometers, which is one to two orders of magnitude shorter than the wavelengths received by the proximity sensor components. The proximity detector components can have signal receivers that receive similar wavelengths, i.e., about 860 nanometers.

In one or more embodiments, each proximity detector component can be an infrared proximity sensor set that uses a signal emitter that transmits a beam of infrared light that reflects from a nearby object and is received by a corresponding signal receiver. Proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

The other components 222 can optionally include a barometer operable to sense changes in air pressure due to elevation changes or differing pressures of the electronic device 200. Where included, in one embodiment the barometer includes a cantilevered mechanism made from a piezoelectric material and disposed within a chamber. The cantilevered mechanism functions as a pressure sensitive valve, bending as the pressure differential between the chamber and the environment changes. Deflection of the cantilever ceases when the pressure differential between the chamber and the environment is zero. As the cantilevered material is piezoelectric, deflection of the material can be measured with an electrical current.

The other components 222 can also optionally include a light sensor that detects changes in optical intensity, color, light, or shadow in the environment of an electronic device. This can be used to make inferences about context such as weather or colors, walls, fields, and so forth, or other cues. An infrared sensor can be used in conjunction with, or in place of, the light sensor. The infrared sensor can be configured to detect thermal emissions from an environment about the electronic device 200. Similarly, a temperature sensor can be configured to monitor temperature about an electronic device.

A context engine 226 can then be operable with the various sensors to detect, infer, capture, and otherwise determine persons and actions that are occurring in an environment about the electronic device 200. For example, where included one embodiment of the context engine 226 determines assessed contexts and frameworks using adjustable algorithms of context assessment employing information, data, and events. These assessments may be learned through repetitive data analysis. Alternatively, a user may employ the user interface 206 to enter various parameters, constructs, rules, and/or paradigms that instruct or otherwise guide the context engine 226 in detecting multi-modal social cues, emotional states, moods, and other contextual information. The context engine 226 can comprise an artificial neural network or other similar technology in one or more embodiments.

In one or more embodiments, the context engine 226 is operable with the one or more processors 202. In some embodiments, the one or more processors 202 can control the context engine 226. In other embodiments, the context engine 226 can operate independently, delivering information gleaned from detecting multi-modal social cues, emotional states, moods, and other contextual information to the one or more processors 202. The context engine 226 can receive data from the various sensors. In one or more embodiments, the one or more processors 202 are configured to perform the operations of the context engine 226.

In one or more embodiments, the one or more processors 202 can be operable with the various authenticators of the authentication system 215. For example, the one or more processors 202 can be operable with a first authenticator and a second authenticator. Where more authenticators are included in the authentication system 215, the one or more processors 202 can be operable with these authenticators as well.

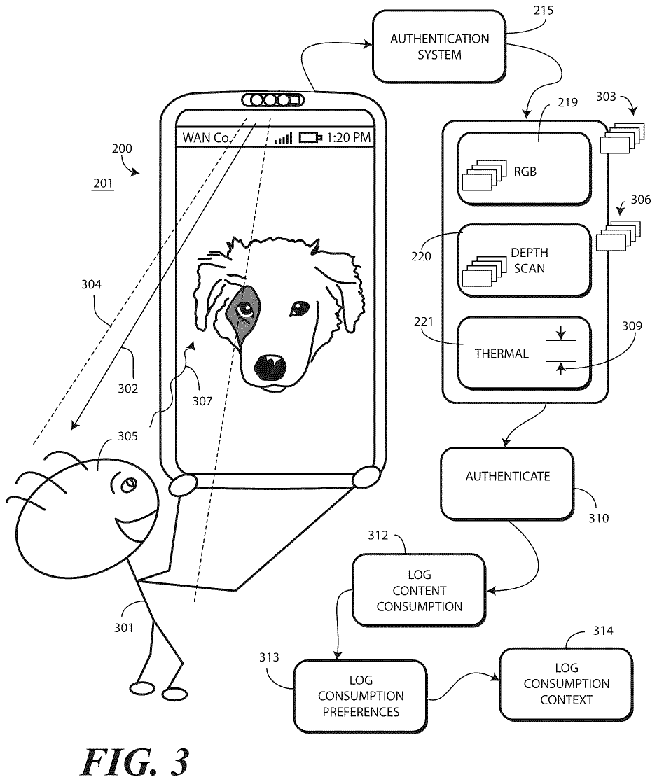

Turning now to FIG. 3, illustrated therein is one explanatory electronic device 200 configured in accordance with one or more embodiments of the disclosure. Also shown in FIG. 3 are one or more method steps for the electronic device 200.

In FIG. 3, a user 301 is present within an environment 201 of the electronic device 200. The user 301 is authenticating himself as an authorized user of the electronic device 200 in accordance with one or more embodiments of the disclosure. In this illustrative embodiment, the authentication process is “touchless” in that the user 301 need not manipulate or interact with the electronic device 200 using his fingers. To the contrary, in accordance with one or more embodiments of the disclosure, the user is authenticated using a combination of two-dimensional imaging, depth scan imaging, thermal sensing, and optionally one or more higher authentication factors.

In this illustrative embodiment, an imager (219) captures at least one image 302 of an object situated within a predefined radius of the electronic device 200, which in this case is the user 301. In one embodiment, the imager (219) captures a single image 302 of the object. In another embodiment, the imager (219) captures a plurality of images of the object.

In one or more embodiments, the one or more images are each a two-dimensional image. For example, in one embodiment the image 302 is a two-dimensional RGB or NIR image. In another embodiment, the image 302 is a two-dimensional infrared image. Other types of two-dimensional images will be obvious to those of ordinary skill in the art having the benefit of this disclosure.

In one or more embodiments, the image 302 can be compared to one or more predefined reference images 303. By making such a comparison, one or more processors (202) can confirm whether the shape, skin tone, eye color, hair color, hair length, and other features identifiable in a two-dimensional image are that of the authorized user identified by the one or more predefined reference images 303.

In addition to the imager (219) capturing the image 302, in one or more embodiments a depth imager (220) captures at least one depth scan 304 of the object when situated within the predefined radius of the electronic device 200. In one embodiment, the depth imager (220) captures a single depth scan 304 of the object. In another embodiment, the depth imager (220) captures a plurality of depth scans of the object. The depth scan 304 creates a depth map of a three-dimensional object, such as the user's face 305. This depth map can then be compared to one or more predefined facial maps 306 to confirm whether the contours, nooks, crannies, curvatures, and features of the user's face 305 are that of the authorized user identified by the one or more predefined facial maps 306.

In one or more embodiments, the image 302 and the depth scan 304 are used in combination for authentication purposes. Illustrating my example, in one or more embodiments one or more processors (202) compare the image 302 with the one or more predefined reference images 303. The one or more processors (202) then compare the depth scan 304 with the one or more predefined facial maps 306. Authentication will fail in one or more embodiments unless the image 302 sufficiently corresponds to at least one of the one or more predefined reference images 303 and the depth scan 304 sufficiently corresponds to at least one of the one or more predefined facial maps 306.

As used herein, “sufficiently” means within a predefined threshold. For example, if one of the predefined reference images 303 includes five hundred reference features, such as facial shape, nose shape, eye color, background image, hair color, skin color, and so forth, the image 302 will sufficiently correspond to at least one of the one or more predefined reference images 303 when a certain number of features in the image 302 are also present in the predefined reference images 303. This number can be set to correspond to the level of security desired. Some users may want ninety percent of the reference features to match, while other users will be content if only eighty percent of the reference features match, and so forth.

As with the predefined reference images 303, the depth scan 304 will sufficiently match the one or more predefined facial maps 306 when a predefined threshold of reference features in one of the facial maps is met. In contrast to two-dimensional features found in the one or more predefined reference images 303, the one or more predefined facial maps 306 will include three-dimensional reference features, such as facial shape, nose shape, eyebrow height, lip thickness, ear size, hair length, and so forth. As before, the depth scan 304 will sufficiently correspond to at least one of the one or more predefined facial maps 306 when a certain number of features in the depth scan 304 are also present in the predefined facial maps 306. This number can be set to correspond to the level of security desired. Some users may want ninety-five percent of the reference features to match, while other users will be content if only eighty-five percent of the reference features match, and so forth.

The use of both the image 302 and the depth scan 304 as combined authentication factors is far superior to using one or the other alone. The depth scan 304 adds a third “z-dimension” to the x-dimension and y-dimension data found in the image 302, thereby enhancing the security of using the user's face 305 as their password in the process of authentication by facial recognition. Another benefit of using the depth scan 304 in conjunction with the image 302 is the prevention of someone “faking” the imager (219) acting alone by taking an image 302 of a picture of the user 301, rather than the user 301 themselves. Illustrating by example, if only the imager (219) is used, a nefarious person trying to get unauthorized access to the electronic device 200 may simply snap a picture of a two-dimensional photograph of the user 301. The use of a depth scan 304 in conjunction with the image 302 prevents this type of chicanery by requiring that a three-dimensional object, i.e., the actual user 301, be present and within the predefined radius before the authentication system 215 authenticates the user 301.

The opposite is also true. Use of only the depth imager (220), without the imager (219), is similarly problematic. If only the depth imager (220) is used, a nefarious actor attempting to gain unauthorized access to the electronic device 200 may create a three-dimensional, lifelike mask of the user 301. However, the use of the image 302 in conjunction with the depth scan 304 prevents this, as features of the user 301 that are hard to replicate with a mask are verified from the image 302, which is a RGB or NIR image in one or more embodiments. Features such as facial shape, nose shape, eye color, hair color, skin color, and so forth can be sufficiently verified by comparing the image 302 to the one or more predefined reference images 303. Advantageously, the use of the image in conjunction with the depth scan 304 prevents this type of chicanery by capturing a color two-dimensional image of the object, thereby confirming that the object looks like the user 301 in addition to being shaped like the user 301.

While the use of both the image 302 and the depth scan 304 as combined authentication factors is far superior to using one or the other alone, as noted above it is contemplated that a nefarious actor may take even more desperate steps attempt to “spoof” the authentication system 215 if the information stored within the electronic device 200 is sufficiently valuable. Consider the situation where the malefactor goes to the extreme of making a three-dimensional mask of the authorized user with Hollywood-caliber hair and make-up so that it is not only shaped like the user 301 but looks like the user 301 as well. While very expensive, such masks can be obtained when the stakes are sufficiently high. If only an image 302 and a depth scan 304 are required for the authentication system 215, this could conceivably result in unauthorized access to the electronic device 200 being obtained.

Advantageously, one or more embodiments of the present disclosure further require a thermal sensor (221) to detect an amount of thermal energy 307 received from an object within a thermal reception radius of the electronic device 200. In one or more embodiments, only where the amount of thermal energy 307 received form the object is within a predefined temperature range 209 will authentication occur, and thus access be granted. Advantageously, this prevents the use of three-dimensional masks from “tricking” the authentication system by masquerading as the actual user 301. Thus, in one or more embodiments, the one or more processors (202) determine whether the amount of thermal energy 307 received from the object, which in this case is the user 301, is within the predefined temperature range 309.

In one or more embodiments, authentication 310 occurs where each of the following is true: the at least one image 302 sufficiently corresponds to at least one of the one or more predefined reference images 303; the at least one depth scan 304 sufficiently corresponds to at least one of the one or more predefined facial maps 306; and the amount of thermal energy 307 received from the object is within the predefined temperature range 309. Where all three are true, in one or more embodiments, the object is authenticated 310 as the user 301 authorized to use the electronic device 200.

In one or more embodiments, when the authentication 310 fails, for whatever reason, the one or more processors (202) can lock or limit full access the electronic device 200 to preclude access to it or the information stored therein. For example, if the at least one image 302 fails to sufficiently correspond to at least one of the one or more predefined reference images 303 the one or more processors (202) can lock the electronic device 200 to preclude access to it or reduce access or the information stored therein.

Similarly, if the at least one depth scan 304 fails to correspond to at least one of the one or more predefined facial maps 306, the one or more processors (202) can lock the electronic device 200 to preclude access to it or the information stored therein. If a mask is being used to spoof the authentication system 215, and the amount of thermal energy 307 received from the object fails to fall within the predefined temperature range 309, the one or more processors (202) can lock the electronic device 200 to preclude access to it or the information stored therein. When the electronic device 200 is locked, the one or more processors (202) may then require additional authentication factors beyond the image 302, the depth scan 304, and the amount of thermal energy 307 to authenticate the user 301 at the next authentication cycle.

In the illustrative embodiment of FIG. 3, the user 301 is consuming content. Specifically, the user 301 is viewing a picture of his dog. While the content is an image in this example, it could be other forms of media as well, including music, movies, videos, electronic books, websites, social media sites, and so forth.

As used herein, “consuming” content means experiencing that content. For a photograph, this would include viewing the photograph. For a video, this would include viewing the video. For an electronic book, this would include reading the electronic book. For music, this would include listening to the music, and so forth.

In one or more embodiments, the one or more processors (202) of the electronic device 200 can maintain a historical log of the content consumed by the user 301 at step 312. This log can include the frequency with which the user 301 has consumed the content, the duration the user 301 has consumed the content, the time of day the user 301 has consumed the content, and so forth. For content having a temporal component, e.g., a video, song, or electronic book, this log can include how much or what percentage of the content is consumed. For example, if the content had been a 200-page electronic book and the user 301 had read to one hundredth page, the log can include the fact that the user 301 has consumed about fifty percent of the content. Other information to keep within the log will be obvious to those of ordinary skill in the art having the benefit of this disclosure.

The one or more processors (202) can further maintain a log of content preferences at step 313. If, for example, the user 301 prefers audio books over electronic books in text form, this can be logged. If the user 301 prefers to watch videos at a lower resolution than the maximum possible to conserve data usage, this can be logged as well. Other information to keep within the log will be obvious to those of ordinary skill in the art having the benefit of this disclosure.

The one or more processors (202) can also maintain a consumption context at step 314. The consumption context can include information such as the locations at which the user 301 has consumed the content. The consumption context can also include preferred conduits for consuming the content. If, for example, a user 301 has a preference of watching streaming video in a particular content delivery application, this can be recorded and logged at step 314. Other information to keep within the log will be obvious to those of ordinary skill in the art having the benefit of this disclosure.

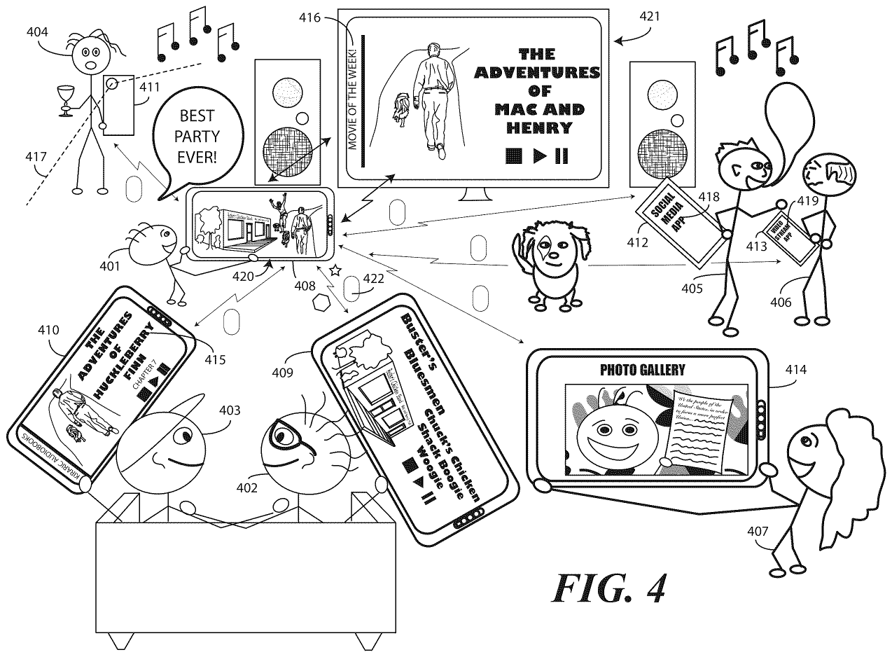

Turning now to FIG. 4, illustrated therein is one explanatory system in accordance with one or more embodiments of the disclosure. The scene is a huge party, with a host 401 and several guests 402,403,404,405,406,407. The host 401 has a host electronic device 408, while each guest 402,403,404,405,406,407 has a guest electronic device 409,410,411,412,413,414. Each guest electronic device 409,410,411,412,413,414 has an application operating locally on its respective guest electronic device 409,410,411,412,413,414 that can output media content 415,416,417,418,419,420.

In this illustrative embodiment, host electronic device 408 has a movie streaming application. In this example, the movie streaming application is outputting media content 416 in the form of a movie and, in particular, the infamous “Adventures of Mac and Henry,” which is being presented as the movie of the week.

The movie “Adventures of Mac and Henry” follows the escapades of two vagabonds, Mac and Henry, as they traverse the countryside, encountering a series of humorous and unpredictable situations. The film opens with Mac and Henry, both drifters with a knack for getting into trouble, stumbling upon a small, sleepy town. Their arrival sets off a chain of events that sees them inadvertently becoming the town's unlikely heroes.

One memorable scene involves Mac and Henry attempting to fix a broken-down car using a series of improvised tools, only to end up causing more chaos than they resolve. The comedic timing and the chemistry between the two lead actors make this scene particularly engaging.

Another standout moment in the film occurs when Mac and Henry find themselves in a high-stakes poker game with a group of seasoned gamblers. Despite their lack of experience, their unorthodox strategies and sheer luck lead to a series of wins, much to the chagrin of the other players. This scene not only showcases the duo's resourcefulness but also highlights the film's underlying theme of friendship and loyalty. The cinematography captures the tension and excitement of the game, while the witty dialogue keeps the audience entertained.

The “Adventures of Mac and Henry” is featured as the movie of the week due to the blend of humor, adventure, and heartwarming moments. The film's ability to balance slapstick comedy with genuine emotional depth makes the movie a standout choice for viewers seeking both laughter and a story. The dynamic between Mac and Henry, coupled with the picturesque countryside setting, creates a visually appealing and thoroughly enjoyable cinematic experience. The film's memorable scenes and the endearing nature of the protagonists ensure that the movie resonates with audiences, making the film a selection for communal viewing.

Since the host 401 fails to pay for an OTT service without commercials, some of the other guests 402,403,404,405,406,407 use their guest electronic devices 409,410,411,412,413,414 for entertainment during the commercials. Illustrating by example, guest 402 uses his guest electronic device 409 to listen to Chuck's Chicken Shack Boogie Woogie by Buster and his legendary Bluesmen (feat. Tommy). By contrast, the application operating on guest electronic device 410 is an audiobook application generating media content 415 in the form of a reading of the Adventures of Huckleberry Finn by Will Wheaton.

Guest 404 is operating a webcam application to capture all the gaiety of the party. Accordingly, the media content 418 generated by the application operating locally on guest electronic device 411 comprises webcam content.

Guest 405 has a social media application operating on his guest electronic device 412. Accordingly, the media content 418 being generated comprises social media content. Guest 406 has a video streaming application operating locally on his guest electronic device 413 outputting media content 419 in the form of streaming video. Guest 407 has a photo gallery application outputting media content 420 in the form of pictures on her guest electronic device 414. These examples of media content are illustrative only, as other forms of media content output by application operating locally on a guest electronic device will be obvious to those of ordinary skill in the art having the benefit of this disclosure.

While each guest 402,403,404,405,406,407 may be momentarily impressed by the rarefied intelligence and taste embodied in their media content selection, they in no way want to miss any parts of the movie being presented on a content presentation companion device 421. The Adventures of Mac and Henry is just too good.

Advantageously, in one or more embodiments the system comprises an electronic device—which could be the host electronic device 408, the content presentation companion device 421, or another electronic device—that determines the presence of a content consumer in a monitored area during the presentation of media content by a media output device. In one or more embodiments, the presence is detected using wireless and proximity device sensors, which indicate the presence of another electronic device in the viewing range of the same media output device, or the presence of a user as detected by a camera or audio signals captured by the electronic device.

In one or more embodiments, the system determines that the consumer in the monitored area has been interrupted while the media content continues to play, using one or more sensors, including an image capturing device positioned to have a field of view of the monitored area and a microphone positioned to detect sounds in or near the monitored area. In one or more embodiments, the system also detects when the electronic device moves out of the viewing range.

In one or more embodiments, the system starts gathering a summary of what is being played on the media output device while the consumer remains interrupted. In one or more embodiments, this process involves interfacing with the media output device to fetch any text (closed caption) tracks where possible via an application interface and capturing the audio from the media output device.

In one or more embodiments, the system converts speech to text to gather what is being rendered, either capturing this on the electronic device or fetching the text from other communicatively connected electronic devices that remain in the viewable range of the media output device. In one or more embodiments, the system determines when the consumer who was interrupted in the monitored area returns, using indicators such as the electronic device moving back into the viewing range or the end of a communication session that the user started participating in actively.

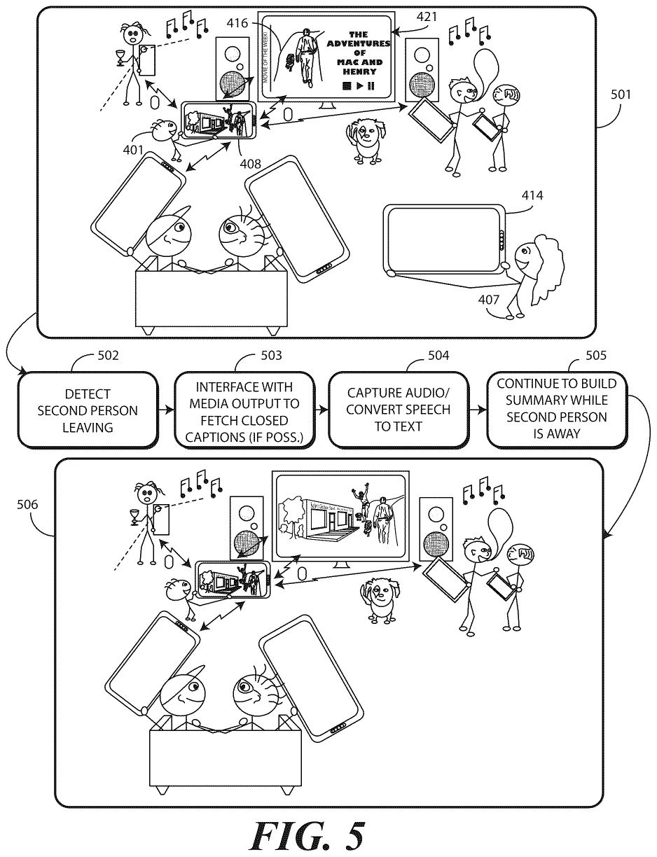

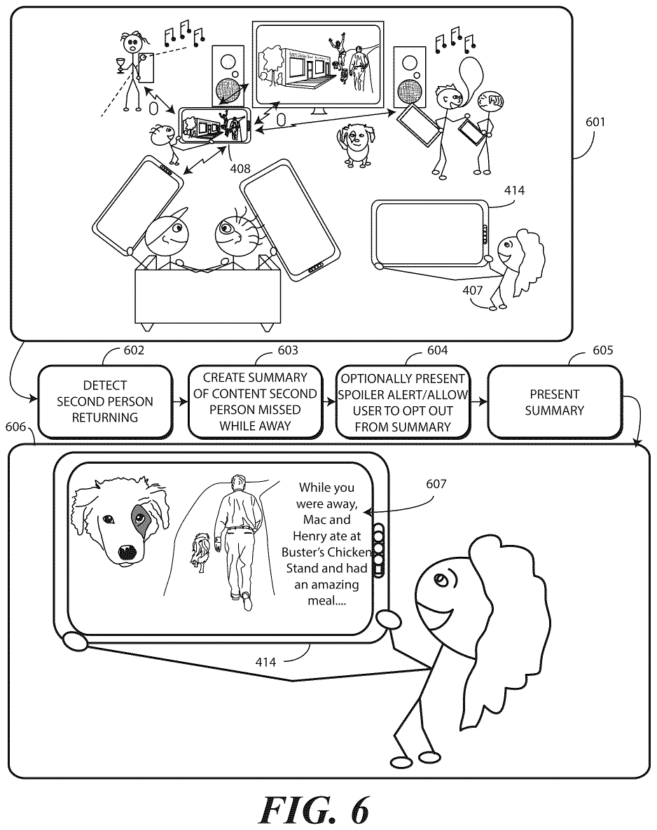

In one or more embodiments, in response to the consumer returning to the monitored area, the system presents a summary of the missed content on the device display. In an embodiment, the system detects that a second consumer is moving out of the monitored area during the presentation of media content by a media output device and maintains a separate summary of the missed content to be presented to the second consumer when the second consumer returns to the monitored area. Turning now to FIGS. 5 and 6, illustrated therein are one or more method steps illustrating how this can occur.

Beginning with FIG. 5, at step 501 we again have our party scene from FIG. 4. As noted above, the host 401 is using the host electronic device 408 to stream the Adventures of Mac and Henry to the roomful of guests. Each guest has a guest electronic device. For example, guest 407 has her guest electronic device 414.

At step 501, host electronic device 408 detects, with one or more sensors of the host electronic device 408, one or more persons (the guests in this example) within a media consumption environment (the room in this example) of the host electronic device 408. In this illustrative embodiment, the host electronic device 408 makes this detection while a companion electronic device 421 in communication with the host electronic device 408 is delivering content 416 to the media consumption environment.

The host electronic device 408 can detect one or more persons within the media consumption environment while the companion electronic device 421 delivers content 416 to the media consumption environment through several different methods. Each method utilizes various sensors and technologies. Discussed below are some methods and their respective advantages. Others will be obvious to those of ordinary skill in the art having the benefit of this disclosure. It should be noted that these techniques can be used alone or in combination.

In one or more embodiments, the host electronic device 408 can use image capture devices, such as cameras, to detect the presence of persons within the media consumption environment. These cameras can capture images or video of the area and use facial recognition or motion detection algorithms to identify individuals.

Advantages offered by the use of image capture devices include the fact that cameras can provide detailed visual information, allowing for accurate identification of individuals. Additionally, continuous video feeds enable real-time detection and tracking of persons. Moreover, advanced algorithms can identify specific individuals, enhancing personalization and security.

In other embodiments, the host electronic device 408 can use microphones to detect sounds within the media consumption environment. By capturing audio signals, the host electronic device 408 can determine the presence of persons based on voice recognition or the detection of specific sounds, such as footsteps or conversations.

Advantages associated with the use of microphones include the fact that microphones can detect presence without requiring direct visual contact. Moreover, the use of microphones allows host electronic device 408 to identify individuals based on their voice patterns. Additionally, microphones are useful for detecting general activity and presence in the environment.

In other embodiments, proximity sensors can detect the presence of persons by measuring the distance between the sensor and nearby objects. These sensors can use infrared, ultrasonic, or radio frequency signals to determine if someone is within a certain range.

Proximity sensors typically consume less power compared to cameras, to name a first advantage associated with their use. Proximity sensors also offer quick response time for detecting the presence of persons entering or leaving the area. What's more, proximity sensors are less invasive as they do not capture visual or audio data.

In still other embodiments, wireless device detection can be used. To wit, in one or more embodiments the host electronic device 408 can detect the presence of other electronic devices, such as smartphones or wearables, within the media consumption environment. This can be achieved through Bluetooth, Wi-Fi, or other wireless communication protocols.

Wireless device detection includes several advantages, one of which is specific device identification. Wireless device detection can identify specific devices and, by extension, their owners. Additionally, wireless device detection works well with other connected devices in a smart home environment. Wireless device detection also is efficient in terms of energy usage.

Gaze detection can be used to identify users within the media consumption environment. Gaze detection involves using cameras or specialized sensors to track the direction of a person's gaze. This method can determine if individuals are looking at the display, indicating their presence and engagement.

A primary advantage offered by the use of gaze detection is that it helps in understanding user engagement with the content. Gaze detection also confirms that individuals are actively watching the content. Gaze detection can be used to tailor content based on where users are looking as well.

Motion sensors can detect movement within the media consumption environment. These sensors can use infrared, ultrasonic, or radar technology to sense motion and determine the presence of persons.

Motion sensors are advantageous in the fact that they can cover large areas and detect movement across the entire environment. Additionally, motion sensors quickly detect any movement, ensuring timely updates on presence. Motion sensors can also be used in various lighting conditions and environments.

By employing these methods, the host electronic device 408 can effectively detect the presence of persons within the media consumption environment, ensuring that the system can gather and present summaries of missed content accurately and efficiently. Each method offers advantages, allowing for a comprehensive and adaptable detection system.

Guest 407, deeply engrossed in the captivating narrative of “The Adventures of Mac and Henry,” finds herself reluctantly needing to leave the media consumption environment. The film, with a blend of humor, adventure, and heartwarming moments, has her completely absorbed. An immediate matter demands her attention. Her smartphone, shown as guest electronic device 414, and which she keeps on silent mode to avoid distractions during the movie, vibrates with a notification from her babysitter.

The message indicates that her young child, who is at home with a babysitter, desperately wants to hear a quick bedtime story before galling her sleep. Despite her strong desire to stay and not miss any part of the movie, a good night's sleep for her child takes precedence. She quickly informs the host and other guests of her situation, expressing her regret for having to step out momentarily.

At step 502, host electronic device 408 determines, using one or more processors operable with the one or more sensors, an interruption of consumption of the content by at least one person of the one or more persons in the media consumption environment.

The one or more processors of host electronic device 408 can determine an interruption of the consumption of content by at least one person within the media consumption environment using various techniques at step 504. These techniques involve the use of sensors and other detection methods to identify when a person stops engaging with the content being presented.

One technique involves using image capture devices, such as cameras, to monitor the media consumption environment. The cameras can capture images or video of the area and use facial recognition or motion detection algorithms to identify individuals. When the camera detects at step 502 that a person, such as guest 407, has left the viewing area, the processors can determine that an interruption has occurred. This method provides detailed visual information, allowing for accurate identification of individuals and real-time detection and tracking of their presence.

Another technique employs microphones to detect sounds within the media consumption environment. By capturing audio signals, the host electronic device 408 can determine at step 502 the presence of persons based on voice recognition or the detection of specific sounds, such as footsteps or conversations. When the microphones detect that the sounds associated with guest 407 have ceased, the processors can infer that guest 407 has left the area.

This method allows for presence detection without requiring direct visual contact and can identify individuals based on their voice patterns. Thus, in one or more embodiments step 502 comprises determining the interruption of the consumption of the content by utilizing a microphone of the electronic device detecting sounds emanating from the at least one person within the media consumption environment.

Proximity sensors can also be used to detect the presence of persons by measuring the distance between the sensor and nearby objects. These sensors can use infrared, ultrasonic, or radio frequency signals to determine if someone is within a certain range. When the proximity sensors no longer detect guest 407 within the predefined range, the processors can determine that an interruption has occurred. Proximity sensors typically consume less power compared to cameras and offer quick response times for detecting the presence of persons entering or leaving the area.

Wireless device detection is another technique that can be employed. The host electronic device 408 can detect the presence of other electronic devices, such as smartphones or wearables, within the media consumption environment through Bluetooth, Wi-Fi, or other wireless communication protocols. When the host electronic device 408 no longer detects the wireless signal from guest device, the processors can determine that guest 407 has left the area.

This method allows for specific device identification and works well with other connected devices in a smart home environment. Thus, in one or more embodiments step 502 comprises detecting the interruption of the consumption of the content using a communication device of the electronic device detecting movement of a companion electronic device beyond the media consumption environment.

Gaze detection can be used to identify users within the media consumption environment. This involves using cameras or specialized sensors to track the direction of a person's gaze. If the sensors detect that guest gaze is no longer directed at the display, the processors can determine that an interruption has occurred.

Gaze detection helps in understanding user engagement with the content and confirms that individuals are actively watching the content. Thus, in one or more embodiments step 502 comprises determining the interruption of the consumption of the content by utilizing an image capture device of the electronic device capturing a gaze of the at least one person being directed away from a display of the electronic device.

Motion sensors can detect movement within the media consumption environment. These sensors can use infrared, ultrasonic, or radar technology to sense motion and determine the presence of persons. When the motion sensors no longer detect movement associated with guest 407, the processors can infer that guest 407 has left the area. Motion sensors can cover large areas and detect movement across the entire environment, ensuring timely updates on presence.

By employing these techniques, the host electronic device 408 can effectively detect interruptions in content consumption, ensuring that the system can gather and present summaries of missed content accurately and efficiently. Each method offers specific advantages, allowing for a comprehensive and adaptable detection system.

At steps 503,504,505 the method of FIG. 5 gathers, by the one or more processors, information related to content portions being presented during the interruption of the consumption of the content by the at least one person. This can be accomplished in a variety of ways.

In one or more embodiments, at step 503 of FIG. 5 the host electronic device 408 interfaces with the media content stream to fetch closed captioning to gather information to compile a summary. This process can involve several technical steps to ensure accurate and comprehensive data collection.

First, the host electronic device 408 can establish a connection with the OTT service that is streaming the content. This connection allows the host electronic device 408 to access the media stream directly.

The media stream typically includes various data tracks, such as video, audio, and closed captioning. Once the connection is established, the host electronic device 408 identifies the closed captioning track within the media stream. Closed captioning is a text representation of the audio content, often used to assist viewers who are deaf or hard of hearing. The closed captioning track contains time-synchronized text that corresponds to the spoken dialogue and other relevant audio cues in the media content.

The host electronic device 408 can then extract the closed captioning data from the media stream. This extraction process can involve parsing the media stream to isolate the closed captioning track and converting the closed captioning track into a readable text format.

The extracted text can include timestamps that indicate when each segment of text is to be displayed, ensuring that the summary aligns with the corresponding portions of the media content. With the closed captioning data extracted, the host electronic device 408 can compile the information into a summary.

In one or more embodiments, this summary includes dialogue and audio cues that occurred during the interruption of content consumption. The summary is designed to provide the user with a concise and coherent overview of the missed content, allowing them to quickly catch up without disrupting the viewing experience for others. By leveraging closed captioning data, the host electronic device 408 ensures that the summary is accurate and reflective of the actual content presented during the interruption.

This method provides a reliable way to gather information and create summaries, enhancing the overall user experience during group media consumption sessions. Thus, in one or more embodiments the gathering of the information related to the content portions being presented during the interruption of the consumption of the content by the at least one person at step 503 comprises fetching closed captioned text corresponding to the content portions being presented during the interruption of the consumption of the content by the at least one person.

At step 504 of FIG. 5, the host electronic device 408 can capture audio from the companion electronic device 421 to gather information about the content being presented during an interruption. This process involves several technical steps to ensure accurate and comprehensive data collection.

First, since the host electronic device 408 has established a connection with the companion electronic device 421, this connection allows the host electronic device 408 to access the audio stream directly from the companion electronic device 421. The audio stream contains the spoken dialogue and other relevant audio cues from the media content being presented.

Once the connection is established, the host electronic device 408 has the ability to capture the audio stream from the companion electronic device 421. This captured audio is then processed using speech-to-text conversion technology. The speech-to-text conversion involves analyzing the audio signals to identify spoken words and converting these words into text format. This conversion process ensures that the spoken dialogue and audio cues are accurately transcribed into text.

The resulting text provides a detailed representation of the audio content presented during the interruption. This text can include dialogue, sound effects, and other audio elements that are necessary for understanding the missed portions of the media content. By converting the audio to text, the host electronic device 408 creates a coherent and readable summary of the missed content.

Additionally, while the host electronic device 408 can perform this audio capture and conversion process, the host electronic device 408 can also retrieve the audio data from other communicatively connected electronic devices that remain in the viewable range of the companion electronic device 421. These connected devices can capture the audio stream and share the data with the host electronic device 408. This collaborative approach ensures that the host electronic device 408 can gather comprehensive audio data even if the host electronic device 408 is not directly capturing the audio itself.

By leveraging both direct audio capture and data retrieval from connected devices, the host electronic device 408 ensures that the summary of the missed content is accurate and reflective of the actual media presented during the interruption. This method provides a reliable way to gather information and create summaries, enhancing the overall user experience during group media consumption sessions.

Thus, in one or more embodiments the gathering of the information related to the content portions being presented during the interruption of the consumption of the content by the at least one person at step 504 comprises using one or more microphones or a communication device to capture audio corresponding to the content portions being presented during the interruption of the consumption of the content by the at least one person. In one or more embodiments, step 504 comprises gathering the information related to the content portions being presented during the interruption of the consumption of the content by the at least one person by converting the audio corresponding to the content portions being presented during the interruption of the consumption of the content by the at least one person to text.

The data gathering process continues at step 505. In one or more embodiments, step 505 comprises gathering, by one or more processors operable with the one or more sensors, information related to content portions being presented during the interruption of the consumption of the media content by the at least one user. In one or more embodiments, step 504 comprises creating, by the one or more processors, a summary of the information related to the content portions being presented during the interruption of the consumption of the media content.

At step 506 of FIG. 5, guest 407 has excused herself from the media consumption environment to read “Tales of Tommy and Kermit” to her child via videoconference. The guest uses her guest electronic device 414, which is equipped with a videoconferencing application, to connect with her child who is at home with a babysitter.

The story, “Tales of Tommy and Kermit,” is a beloved children's book that features the adventures of a young horse named Tommy and his friend, Kermit. The narrative is filled with whimsical tales and gentle humor, making the story an ideal bedtime story. As guest 407 begins reading, the soothing tone of her voice and the engaging storyline capture the child's attention. The videoconferencing application allows the child to see the illustrations in the book, enhancing the storytelling experience.

The child, comforted by the familiar story and the presence of their parent, gradually relaxes. The gentle rhythm of the narrative and the calming effect of the videoconference create a peaceful atmosphere, helping the child to unwind. As the story progresses, the child becomes drowsier.

The adventures of Tommy and Kermit, filled with playful escapades and heartwarming moments, provide a sense of security and comfort. By the time guest 407 reaches the end of the book, the child has drifted off to sleep, lulled by the soothing combination of the story and the videoconference. Guest 407 quietly ends the call, reassured that her child is peacefully asleep.

Turning now to FIG. 6, at step 601 guest 407 returns with her guest electronic device 414 to the media consumption environment. Excitedly, at step 601 guest 407 is ready to catch up on the missed content with the help of the summary generated by the system.

At step 602, one or more processors of host electronic device detect a cessation of the interruption of the consumption of the content by the at least one person. This can be accomplished in a variety of ways, including those described above with reference to steps (501,502) of FIG. 5.

Illustrating by example, in one or more embodiments step 602 comprises detecting the cessation of the interruption of the consumption of the content by the at least one person by using a microphone of the host electronic device 408 to detect a renewal of sounds emanating from the at least one person within the media consumption environment. In other embodiments, step 602 can comprise a communication device of the host electronic device 408 detecting movement of a companion electronic device, e.g., guest electronic device 414, into the media consumption environment. Other techniques will be obvious to those of ordinary skill in the art having the benefit of this disclosure.

At step 603, one or more processors of the host electronic device 408 create a summary of content guest 407 missed while guest 407 was away from the media consumption environment. In one or more embodiments, the summary includes a spoiler alert notification. In one or more embodiments, the summary is created from audio associated with the content, as previously described. In one or more embodiments, step 603 comprises creating, by the one or more processors, the summary from the information related to content portions being presented during the interruption of the consumption of the content by the at least one person.

At step 605, in response to the one or more sensors detecting a cessation of the interruption of the consumption of the content by the at least one person, the method comprises causing, by the one or more processors, presentation of a summary of the information related to the content portions being presented during the interruption of the consumption of the content to the media consumption environment.

As shown at step 606, such a summary 607 is being presented on guest electronic device 414. Since the summary was created on host electronic device 408, at step 606 the presentation of the summary 607 of the information related to the content portions being presented during the interruption of the consumption of the content to the media consumption environment occurs on another electronic device, namely, guest electronic device 414.

When the causing presentation, by the one or more processors on a user interface of the another electronic device at step 605 occurs when there are one or more spoilers in the portions being presented during the interruption of the consumption of the content, optional step 604 can comprise presenting a spoiler alert notice. In one or more embodiments, when user input is received by the user interface in response to the spoiler alert, step 604 comprises omitting the causing the presentation of the summary of the information related to the content portions being presented during the interruption of the consumption of the content.

The summary 607 can be presented in a variety of ways. At step 606, the summary 607 is presented as text on the user interface of guest electronic device 414. However, the summary 607 can be presented in other ways as well. Indeed, in one or more embodiments the summary 607 is presented as audio output in the voice of a participant depicted in the content. This embodiment would allow guest 407 to hear the summary 607 in the voice of Buster himself!

Thus, in one or more embodiments step 605 comprises causing a presentation, by the one or more processors of the summary of the information related to the content portions being presented during the interruption of the consumption of the media content on a user interface of another electronic device situated within the media consumption environment in response to detecting the cessation of the interruption. In one or more embodiments, host electronic device 408 does this by pushing the summary 607 to guest electronic device 414. In other embodiments, guest electronic device 414 can query host electronic device 408 to obtain the summary 607. Other techniques will be obvious to those of ordinary skill in the art having the benefit of this disclosure.

As noted, the summary 607 can be presented in a variety of ways. In the context of the described system, the summary 607 can be presented to guest 407 in various ways at step 606. Each method of presentation offers advantages, enhancing the user experience and ensuring that the guest can quickly catch up on missed content without disrupting the viewing experience for others.

One way to present the summary is through text displayed on the user interface of guest electronic device 414. This method involves converting the missed content into a readable text format, which can be easily displayed on the screen of the device. The advantage of this approach is that the guest can read the summary at their own pace, ensuring they can fully comprehend the missed portions before rejoining the viewing session. Text summaries are also discreet and can be reviewed without disturbing others.

Another method is presenting the summary as audio output. This involves converting the missed content into an audio format, which can be played back to the guest through their device's speakers or headphones. The audio summary can be delivered in the voice of a participant depicted in the content, adding a personalized touch. The advantage of audio summaries is that they allow the guest to listen to the missed content while performing other tasks, making the audio summary a convenient option for multitasking. Additionally, audio summaries can be engaging and immersive, providing a more dynamic way to catch up on missed content.

A third method is presenting the summary as a video. This involves creating a short video clip that highlights the moments and developments that occurred during the guest's absence. The video summary can include visual and audio elements, providing a comprehensive overview of the missed content. The advantage of video summaries is that they offer a rich, multimedia experience, making the content easier for the guest to understand the context and nuances of the missed portions. Video summaries can be particularly useful for content with complex visual elements, such as action scenes or intricate plot developments.

Each of these methods—text, audio, and video—offers distinct advantages, catering to different preferences and situations. Text summaries provide a quick and quiet way to catch up, audio summaries offer convenience and engagement, and video summaries deliver a rich, immersive experience. By offering multiple presentation options, the system ensures that guests can choose the method that suits their needs, enhancing the overall enjoyment and cohesion of shared entertainment moments. Other techniques will be obvious to those of ordinary skill in the art having the benefit of this disclosure.

In FIGS. 5 and 6, host electronic device 408 has been described illustratively as detecting the interruption of the content, the cessation of the interruption, and creating the summary. However, it should be noted that this function can be performed by other devices as well, including companion electronic device 421, any of the guest devices, a dongle connected to companion electronic device 421, or a combination of devices. Indeed, these functions can even be distributed across various devices within the system. Here are some examples of how different devices can perform these functions:

Companion electronic device 421 can use sensors, such as cameras or microphones, to detect when a user leaves the viewing area or stops engaging with the content. Companion electronic device 421 can also detect when the user returns to the viewing area using similar sensors. Companion electronic device 421 can gather information about the missed content and generate a summary using the processing capabilities of companion electronic device 421.

Each guest device can monitor the user's engagement with the content. For example, a guest's smartphone can detect when the user moves away from the viewing area. Guest devices can detect when their users return to the viewing area. Guest devices can gather and process information about the missed content and generate summaries for their respective users.

A dongle connected to companion electronic device 421 can use the sensors of the dongle to detect interruptions in content consumption. The dongle can also detect when the user returns to the viewing area. The dongle can gather information about the missed content and generate a summary, either independently or in conjunction with companion electronic device 421.

The system can use a combination of sensors from the host electronic device 408, companion electronic device 421, and guest devices to detect interruptions. Similarly, the system can use a combination of sensors from multiple devices to detect when users return to the viewing area. The processing power of multiple devices can be leveraged to gather information and create summaries.

For example, the host electronic device 408 can fetch closed captioned text, while a guest device captures audio and converts the audio to text. The combined data can then be used to generate a comprehensive summary. By distributing these functions across various devices, the system can ensure redundancy, improve accuracy, and enhance the overall user experience. This flexibility allows the system to adapt to different configurations and user preferences, making the system more robust and versatile.

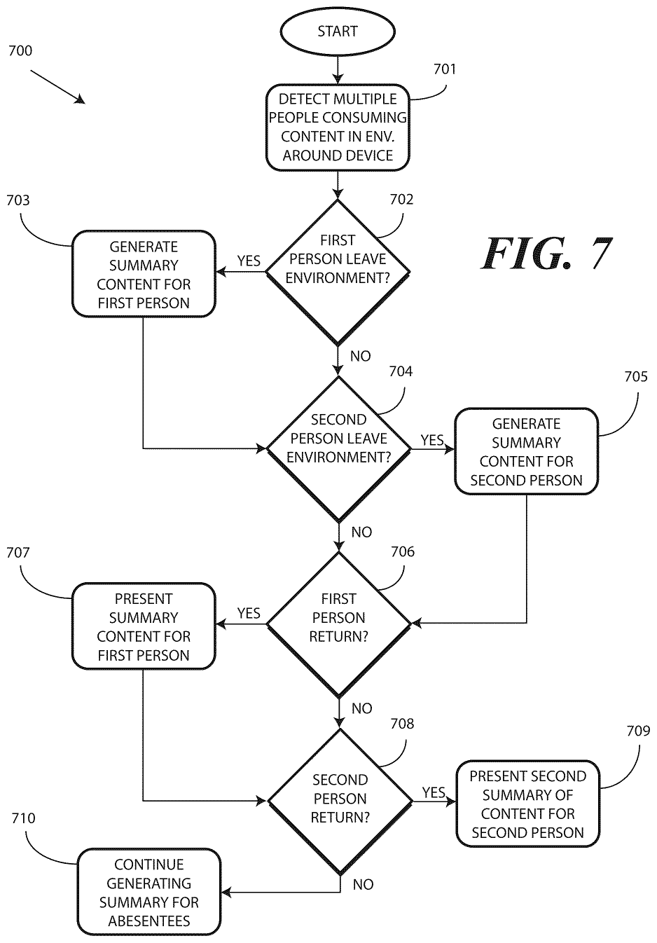

In FIGS. 5 and 6, for ease of illustration the example has depicted a single user leaving the media consumption environment and returning. However, the system can perform the summarization function or multiple users as well. Illustrating by example, if the one or more persons having consumption of content interrupted comprises a plurality of persons, such as when the at least one person comprises a first person and a second person, the summary 607 can comprise a first summary summarizing the portions being presented during the interruption of the consumption of the content by the first person and a second summary summarizing the portions being presented during the interruption of the consumption of the content by the second person. Turning now to FIG. 7, illustrated therein is one method 700 for doing so.

At step 701, the method detects, with one or more sensors of an electronic device, one or more persons within a media consumption environment of the electronic device while a companion electronic device in communication with the electronic device is delivering content to the media consumption environment. At step 702, the method 700 determines, by one or more processors operable with the one or more sensors, an interruption of consumption of the content by at least one person of the one or more persons and, more particularly, a first person. At step 703, the method 700 generates a summary of content for the first person.

At step 704, the method 700 determines, by one or more processors operable with the one or more sensors, an interruption of consumption of the content by at least one other person of the one or more persons and, more particularly, a second person. At step 705, the method 700 generates a summary of content for the second person.

At step 706, one or more sensors detect a cessation of the interruption of the consumption of the content by the first person. As such, step 707 causes presentation of a summary of the information related to the content portions being presented during the interruption of the consumption of the content to the media consumption environment by the first person.

At step 708, one or more sensors detect a cessation of the interruption of the consumption of the content by the second person. As such, step 709 causes presentation of a summary of the information related to the content portions being presented during the interruption of the consumption of the content to the media consumption environment by the second person.

Thus, in the method 700 of FIG. 7, the one or more persons comprises a plurality of persons, with the at least one person comprises a first person and a second person for illustrative purposes. Step 710 can repeat the process for others. At step 707 the summary comprises a first summary summarizing the portions is being presented during the interruption of the consumption of the content by the first person, while at step 708 a second summary summarizing the portions is being presented during the interruption of the consumption of the content by the second person.

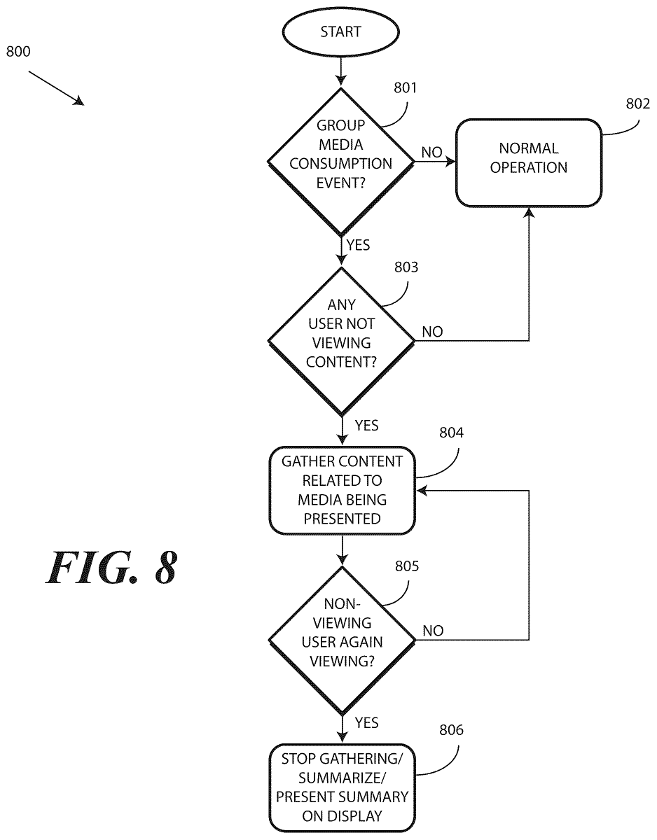

Turning now to FIG. 8, illustrated therein is another explanatory method 800 in accordance with one or more embodiments of the disclosure. The method begins at decision 801, which detects, using one or more sensors of an electronic device, whether one or more persons within a media consumption environment of the electronic device while a companion electronic device in communication with the electronic device is delivering content to the media consumption environment. Where there is only one person, normal operation occurs at step 802.

Decision 803 then determines, again using one or more sensors, whether there is an interruption of consumption of media content by at least one user within a media consumption environment. If not, normal operation occurs at step 802.

However, when decision 803 determines there is an interruption of consumption of media content by at least one user within a media consumption environment. If not, normal operation occurs at step 802, step 804 comprises gathering, by one or more processors operable with the one or more sensors, information related to content portions being presented during the interruption of the consumption of the media content by the at least one user. In one or more embodiments, step 804 comprises creating, by the one or more processors, a summary of the information related to the content portions being presented during the interruption of the consumption of the media content.

Decision 805 then determines whether there is a cessation of the interruption of the consumption of the media content by the at least one user. If not, the method 800 returns to step 804. Otherwise, step 806 comprises causing a presentation, by the one or more processors § of the summary of the information related to the content portions being presented during the interruption of the consumption of the media content on a user interface of another electronic device situated within the media consumption environment in response to detecting the cessation of the interruption.

In one or more embodiments, the summary caused to be presented at step 806 includes a spoiler alert notification. In one or more embodiments, the summary caused to be presented at step 806 is presented in the voice of a participant depicted in the content.

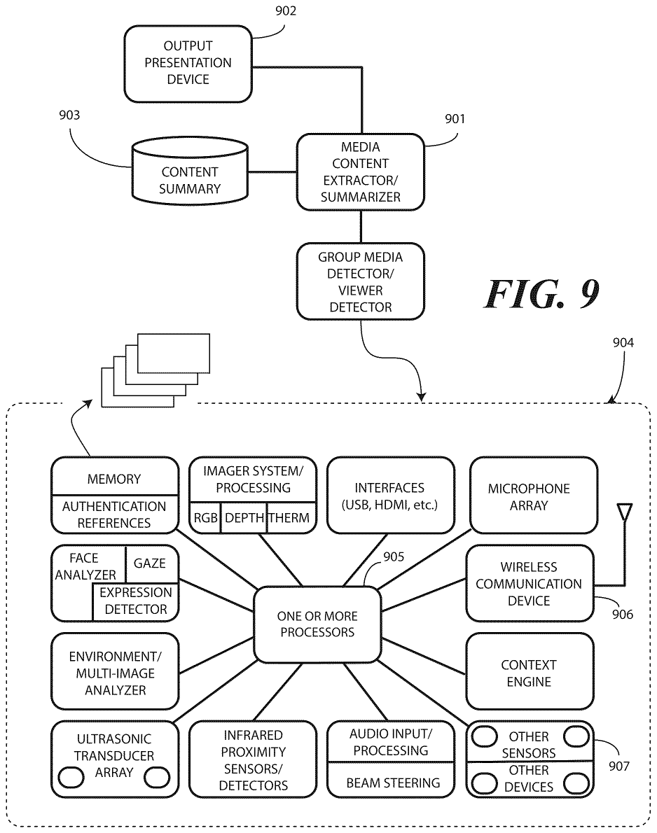

Turning now to FIG. 9, illustrated therein is an explanatory system in accordance with one or more embodiments of the disclosure. Also shown in FIG. 9 is a block diagram schematic 904 of the group media detector/viewer detector. Many of the components of the block diagram schematic 904 were described above with reference to FIG. 2 and will not be repeated. However, items of note in the block diagram schematic include the one or more processors 905, the one or more sensors 907 and the communication device 906.

In one or more embodiments, the one or more processors 905, in response to the one or more sensors 907 detecting an interruption of consumption of content being presented by a user interface 902 of a companion electronic device to a media consumption environment by at least one person, utilized a media content extractor/summarizer 901 to generate a summary 903 of content portions being presented during the interruption of the consumption of the content by the at least one person. In one or more embodiments, the one or more processors 905 cause a presentation of the summary 903 in response to the one or more sensors 907 detecting a cessation of the interruption of the consumption of the content by the at least one person.

In one or more embodiments, the communication device 906 is in communication with at least one other electronic device belonging to the at least one person. In one or more embodiments, the one or more processors 905 cause the presentation of the summary 903 by causing the communication device 906 to deliver the summary across a network to the at least one other electronic device. In other embodiments, the one or more processors 905 cause the presentation of the summary 903 in response to a query received by the communication device 906 from the at least one other electronic device in response to the cessation of the interruption of the consumption of the content by the at least one person.

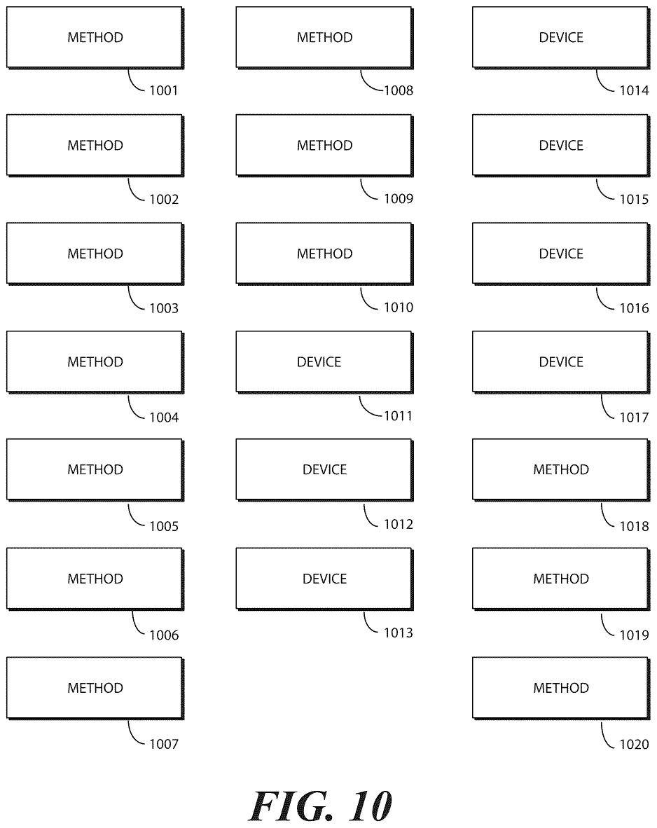

Turning now to FIG. 10, illustrated therein are various embodiments of the disclosure. The embodiments of FIG. 10 are shown as labeled boxes in FIG. 10 due to the fact that the individual components of these embodiments have been illustrated in detail in FIGS. 1-9, which precede FIG. 10. Accordingly, since these items have previously been illustrated and described, their repeated illustration is no longer essential for a proper understanding of these embodiments. Thus, the embodiments are shown as labeled boxes.

At 1001, a method in an electronic device comprises detecting, with one or more sensors of the electronic device, one or more persons within a media consumption environment of the electronic device while a companion electronic device in communication with the electronic device is delivering content to the media consumption environment. At 1001, the method comprises determining, by one or more processors operable with the one or more sensors, an interruption of consumption of the content by at least one person of the one or more persons.

At 1001, the method comprises gathering, by the one or more processors, information related to content portions being presented during the interruption of the consumption of the content by the at least one person. At 1001, the method comprises, in response to the one or more sensors detecting a cessation of the interruption of the consumption of the content by the at least one person, causing, by the one or more processors, presentation of a summary of the information related to the content portions being presented during the interruption of the consumption of the content to the media consumption environment.

At 1002, the method of 1001 comprises gathering the information related to the content portions being presented during the interruption of the consumption of the content by the at least one person by fetching closed captioned text corresponding to the content portions being presented during the interruption of the consumption of the content by the at least one person. At 1003, the method of 1001 comprises gathering the information related to the content portions being presented during the interruption of the consumption of the content by the at least one person by using one or more microphones or a communication device to capture audio corresponding to the content portions being presented during the interruption of the consumption of the content by the at least one person.

At 1004, the method of 1003 comprises gathering the information related to the content portions being presented during the interruption of the consumption of the content by the at least one person by converting the audio corresponding to the content portions being presented during the interruption of the consumption of the content by the at least one person to text. At 1005, the method of 1001 comprises creating, by the one or more processors, the summary from the information related to content portions being presented during the interruption of the consumption of the content by the at least one person.

At 1006, the method of 1001 comprises determining the interruption of the consumption of the content by an image capture device of the electronic device capturing a gaze of the at least one person being directed away from a display of the electronic device. At 1007, the method of 1001 comprises determining the interruption of the consumption of the content by a microphone of the electronic device detecting sounds emanating from the at least one person within the media consumption environment.

At 1008, the method of 1001 comprises determining the interruption of the consumption of the content by a communication device of the electronic device detecting movement of a companion electronic device beyond the media consumption environment. At 1009, the method of 1001 comprises detecting the cessation of the interruption of the consumption of the content by the at least one person by a microphone of the electronic device detecting a cessation of sounds from emanating from the at least one person within the media consumption environment.

At 1010, the method of 1001 comprises detecting the cessation of the interruption of the consumption of the content by the at least one person by a communication device of the electronic device detecting movement of a companion electronic device into the media consumption environment. At 1011, the method of 1001 comprises the one or more persons comprising a plurality of persons. At 1011, the at least one person comprises a first person and a second person. At 1011, the summary comprises a first summary summarizing the portions being presented during the interruption of the consumption of the content by the first person and a second summary summarizing the portions being presented during the interruption of the consumption of the content by the second person.

At 1012, the method of 1011 comprises the presentation of the summary of the information related to the content portions being presented during the interruption of the consumption of the content to the media consumption environment occurring on another electronic device. At 1013, the method of 1012 comprises causing presentation, by the one or more processors on a user interface of the another electronic device when there are one or more spoilers in the portions being presented during the interruption of the consumption of the content, a spoiler alert notice. At 1013, when user input is received by the user interface in response to the spoiler alert, the method comprises omitting the causing the presentation of the summary of the information related to the content portions being presented during the interruption of the consumption of the content.

At 1014, an electronic device comprises one or more sensors and one or more processors operable with the one or more sensors. At 1014, the one or more processors, in response to the one or more sensors detecting an interruption of consumption of content being presented by a user interface of a companion electronic device to a media consumption environment by at least one person, generate a summary of content portions being presented during the interruption of the consumption of the content by the at least one person and cause a presentation of the summary in response to the one or more sensors detecting a cessation of the interruption of the consumption of the content by the at least one person.

At 1015, the electronic device of 1014 further comprises a communication device in communication with at least one other electronic device belonging to the at least one person. At 1015, the one or more processors cause the presentation of the summary by causing the communication device to deliver the summary across a network to the at least one other electronic device.

At 1016, the electronic device of 1014 further comprises a communication device in communication with at least one other electronic device belonging to the at least one person. AT 1016, the one or more processors cause the presentation of the summary in response to a query received by the communication device from the at least one other electronic device in response to the cessation of the interruption of the consumption of the content by the at least one person. At 1017, the summary being or 1015 is created from audio associated with the content.

At 1018, a method in an electronic device comprises detecting, with one or more sensors of the electronic device, an interruption of consumption of media content by at least one user within a media consumption environment. At 1018, the method comprises gathering, by one or more processors operable with the one or more sensors, information related to content portions being presented during the interruption of the consumption of the media content by the at least one user; creating, by the one or more processors, a summary of the information related to the content portions being presented during the interruption of the consumption of the media content.

At 1018, the method comprises detecting, with the one or more sensors, a cessation of the interruption of the consumption of the media content by the at least one user. At 1018, the method comprises causing a presentation, by the one or more processors of the summary of the information related to the content portions being presented during the interruption of the consumption of the media content on a user interface of another electronic device situated within the media consumption environment in response to detecting the cessation of the interruption.

At 1019, the summary of 1018 includes a spoiler alert notification. At 1020, the summary of 10108 is in the voice of a participant depicted in the content.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in one embodiment, the electronic device is a smartphone equipped with a combination of image capture devices, such as cameras, and audio sensors, like microphones, to detect interruptions in content consumption. The cameras can capture images or video of the media consumption environment, using facial recognition or motion detection algorithms to identify when a user leaves the viewing area. The microphones can detect sounds, such as footsteps or conversations, to determine when a user stops engaging with the content.

In another embodiment, the electronic device is a tablet that utilizes proximity sensors to measure the distance between the sensor and nearby objects, determining if someone is within a certain range. This method is less invasive as the tablet does not capture visual or audio data. Additionally, the tablet can use wireless device detection to identify the presence of other electronic devices, such as smartphones or wearables, within the media consumption environment through Bluetooth, Wi-Fi, or other wireless communication protocols.

In yet another embodiment, the electronic device is a smart TV that employs gaze detection technology, using cameras or specialized sensors to track the direction of a person's gaze. This method helps in understanding user engagement with the content and confirms that individuals are actively watching the content. The smart TV can also use motion sensors to detect movement within the media consumption environment, ensuring timely updates on presence. Each of these embodiments demonstrates the adaptability of the electronic device in various configurations and operational methods, enhancing the overall user experience during group media consumption sessions.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
detecting, with one or more sensors of the electronic device, one or more persons within a media consumption environment of the electronic device while a companion electronic device in communication with the electronic device is delivering content to the media consumption environment;
determining, by one or more processors operable with the one or more sensors, an interruption of consumption of the content by at least one person of the one or more persons;
gathering, by the one or more processors, information related to content portions being presented during the interruption of the consumption of the content by the at least one person; and
in response to the one or more sensors detecting a cessation of the interruption of the consumption of the content by the at least one person, causing, by the one or more processors, presentation of a summary of the information related to the content portions being presented during the interruption of the consumption of the content to the media consumption environment.

2. The method of claim 1, wherein gathering the information related to the content portions being presented during the interruption of the consumption of the content by the at least one person comprises fetching closed captioned text corresponding to the content portions being presented during the interruption of the consumption of the content by the at least one person.

3. The method of claim 1, wherein gathering the information related to the content portions being presented during the interruption of the consumption of the content by the at least one person comprises using one or more microphones or a communication device to capture audio corresponding to the content portions being presented during the interruption of the consumption of the content by the at least one person.

4. The method of claim 3, wherein the gathering the information related to the content portions being presented during the interruption of the consumption of the content by the at least one person further comprises converting the audio corresponding to the content portions being presented during the interruption of the consumption of the content by the at least one person to text.

5. The method of claim 1, further comprising creating, by the one or more processors, the summary from the information related to content portions being presented during the interruption of the consumption of the content by the at least one person.

6. The method of claim 1, wherein the determining the interruption of the consumption of the content comprises an image capture device of the electronic device capturing a gaze of the at least one person being directed away from a display of the electronic device.

7. The method of claim 1, wherein the determining the interruption of the consumption of the content comprises a microphone of the electronic device detecting sounds emanating from the at least one person within the media consumption environment.

8. The method of claim 1, wherein the determining the interruption of the consumption of the content comprises a communication device of the electronic device detecting movement of a companion electronic device beyond the media consumption environment.

9. The method of claim 1, wherein the detecting the cessation of the interruption of the consumption of the content by the at least one person comprises a microphone of the electronic device detecting a renewal of sounds emanating from the at least one person within the media consumption environment.

10. The method of claim 1, wherein the detecting the cessation of the interruption of the consumption of the content by the at least one person comprises a communication device of the electronic device detecting movement of a companion electronic device into the media consumption environment.

11. The method of claim 1, wherein:
the one or more persons comprises a plurality of persons;
the at least one person comprises a first person and a second person; and
the summary comprises a first summary summarizing the content portions being presented during the interruption of the consumption of the content by the first person and a second summary summarizing the content portions being presented during the interruption of the consumption of the content by the second person.

12. The method of claim 1, wherein the presentation of the summary of the information related to the content portions being presented during the interruption of the consumption of the content to the media consumption environment occurs on another electronic device.

13. The method of claim 12, further comprising:
causing presentation, by the one or more processors on a user interface of the another electronic device when there are one or more spoilers in the portions being presented during the interruption of the consumption of the content, a spoiler alert notice; and
when user input is received by the user interface in response to the spoiler alert, omitting the causing the presentation of the summary of the information related to the content portions being presented during the interruption of the consumption of the content.

14. An electronic device, comprising:
one or more sensors; and
one or more processors operable with the one or more sensors;
wherein the one or more processors, in response to the one or more sensors detecting an interruption of consumption of content being presented by a user interface of a companion electronic device to a media consumption environment by at least one person, generate a summary of content portions being presented during the interruption of the consumption of the content by the at least one person and cause a presentation of the summary in response to the one or more sensors detecting a cessation of the interruption of the consumption of the content by the at least one person.

15. The electronic device of claim 14, further comprising a communication device in communication with at least one other electronic device belonging to the at least one person, wherein the one or more processors cause the presentation of the summary by causing the communication device to deliver the summary across a network to the at least one other electronic device.

16. The electronic device of claim 14, further comprising a communication device in communication with at least one other electronic device belonging to the at least one person, wherein the one or more processors cause the presentation of the summary in response to a query received by the communication device from the at least one other electronic device in response to the cessation of the interruption of the consumption of the content by the at least one person.

17. The electronic device of claim 15, wherein the summary is created from audio associated with the content.

18. A method in an electronic device, the method comprising:
detecting, with one or more sensors of the electronic device, an interruption of consumption of media content by at least one user within a media consumption environment;
gathering, by one or more processors operable with the one or more sensors, information related to content portions being presented during the interruption of the consumption of the media content by the at least one user;
creating, by the one or more processors, a summary of the information related to the content portions being presented during the interruption of the consumption of the media content;
detecting, with the one or more sensors, a cessation of the interruption of the consumption of the media content by the at least one user; and
causing a presentation, by the one or more processors of the summary of the information related to the content portions being presented during the interruption of the consumption of the media content on a user interface of another electronic device situated within the media consumption environment in response to detecting the cessation of the interruption.

19. The method of claim 18, wherein the summary includes a spoiler alert notification.

20. The method of claim 18, wherein the summary is presented in the voice of a participant depicted in the media content.
